(19) United States
(12) Patent Application Publication
(10) Pub. No.: US 2009/0174898 A1
(43) Pub. Date: Jul. 9, 2009

(54) PLURALITY OF IMAGE PROCESSING IN IMAGE PROCESSING SYSTEM HAVING ONE OR MORE NETWORK-CONNECTED IMAGE PROCESSING APPARATUSES

(75) Inventor: Takashi Ono, Inagi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/346,197

(22) Filed: Dec. 30, 2008

(30) Foreign Application Priority Data
Jan. 9, 2008 (JP) 2008-002486(PAT.)

(51) Int. Cl. G06F 15/00

(52) U.S. Cl. 358/1.15

(57) ABSTRACT

An image processing apparatus in an image processing system in which a plurality of image processing apparatuses is connected via a network performs processing as below. The apparatus judges a type of data, sets priorities of image processings for the data in accordance with the judged type, obtains a plurality of image processing capabilities provided for the plurality of image processing apparatuses via the network, and determines a processing route along which the data is processed through the plurality of image processing apparatuses. Image processings for the data are performed in the image processing system by transferring the data along the determined processing route.

### BACKGROUND OF THE INVENTION

1. Field of the Invention

The present invention relates to an image processing apparatus in an image processing system comprising one or more network-connected image processing apparatuses, control method in the system and a program of the control method.

2. Description of the Related Art

A technique is developed which performs image copying by outputting an image input at an image input device connected to a network at other image processing apparatus connected to the network (Japanese Patent Laid-open No. H11-331455 (1999)). The copying function that performs image input and image output on different devices on the network is referred to as remote copy. In remote copy, a user can select apparatus that satisfies an output condition set by the user from among a plurality of image processing apparatuses connected to the network by the user operating user interface and output an image.

In a system having a plurality of network-connected image processing apparatuses, a technique for appropriately configures various functions equipped with image processing apparatuses in an image processing apparatus which is connected to the image processing apparatuses and for finding to indicate an image processing apparatus of the image processing apparatuses which is able to have an output in accordance with the resulted configuration. This allows a configuration of function and an output without considering capability of each of the image processing apparatuses, when a user performs remote copy (Japanese Patent Laid-open No. H10-13580 (1998)).

To output images on an image processing apparatus, a plurality of image processes is necessary. In respect of each image processing, each apparatus has its merit and demerit. Therefore, a combination of all image processes by image processing apparatuses selected as the above-mentioned prior art is not always an optimal image process for an output image. Thus an optimal output result cannot be obtained. Further, to select and utilize image processes suitable for various kinds of data in an image, a user must be conscious of image processing capability of image processing apparatuses and customize a configuration of an image processing apparatus. In this case, a user should know capabilities of image processing apparatuses and have much time and trouble in configuring an image processing apparatus.

It is an object of the present invention to realize high-image quality output in a system comprising a plurality of network-connected image processing apparatuses, and efficiently perform processing for the high-image quality output.

### SUMMARY OF THE INVENTION

The present invention in order to solve the problem provides an image processing apparatus in an image processing system constituted of a plurality of image processing apparatuses connected to a network, in order to solve above-mentioned problems. The apparatus comprises judgment means for judging a type of data; set means for setting priorities of image processings for the data in accordance with the judged type; obtainment means for obtaining a plurality of image processing capabilities provided for the plurality of image processing apparatuses via the network; and determination means for determining a processing route along which the data is processed through the plurality of image processing apparatuses; wherein image processings for the data are performed by transferring the data along the determined processing route.

Further features of the present invention will become apparent from the following description of exemplary embodiments (with reference to the attached drawings)

### BRIEF DESCRIPTION OF THE DRAWINGS

In the appended drawings:

FIG. 1 is a sectional side view illustrating structure of printing device (MFP) according to Embodiment 1 of the present invention;

FIG. 2 is a view illustrating an example of system configuration according to Embodiment 1;

FIG. 3 is a block diagram illustrating a configuration of control unit of each device according to Embodiment 1;

FIG. 4 is a block diagram illustrating a configuration of controller software according to Embodiment 1;

FIG. 5 is a view illustrating data flows in scanning copy according to Embodiment 1;

FIG. 6 is a view illustrating data flows at metadata generation according to Embodiment 1;

FIG. 7 is a view illustrating an example of a block selection at vectorization processing according to Embodiment 1;

FIG. 8 is a view illustrating data flows at PDL print according to Embodiment 1;

FIG. 9 is a diagram showing the relationship of FIG. 9A, FIG. 9B and FIG. 9C;

FIG. 9A is a left side view of a flowchart illustrating data flows at document generation from image according to Embodiment 1;

FIG. 9B is a center view of the flowchart illustrating data flows at document generation from image according to Embodiment 1;

FIG. 9C is a right side view of the flowchart illustrating data flows at document generation from image according to Embodiment 1;

FIG. 10 is a view illustrating a priority processing capability table according to Embodiment 1;

FIG. 11 is a view illustrating data flows at document generation from PDL according to Embodiment 1;

FIG. 12 is a flow chart illustrating processing of Document transfer and printing according to Embodiment 1;

FIG. 13 is a view illustrating data structure of document according to Embodiment 1;

FIG. 14 is a view illustrating a specific example of document data according to Embodiment 1;

FIG. 15A is a view illustrating storing structure of document according to Embodiment 1;

FIG. 15B is a view illustrating storing structure of document according to Embodiment 1;

FIG. 16 is a view illustrating a screen displayed on console according to Embodiment 1;

FIG. 17 is a flow chart illustrating processing of Box printing instruction according to Embodiment 1;

FIG. 18 is a flow chart illustrating processing of processing capability table generation according to Embodiment 1;

FIG. 19 is a view illustrating a processing capability table according to Embodiment 1;

FIG. 20 is a diagram showing the relationship of FIG. 20A and FIG. 20B;

FIG. 20A is a left side view of a flowchart illustrating processing of processing route generation according to Embodiment 1;

FIG. 20B is a right side view of the flowchart illustrating processing of processing route generation according to Embodiment 1;

FIG. 21 is a flow chart illustrating processing of processing route generation according to Embodiment 1;

FIG. 22A is a view illustrating an example of screens displayed on console according to Embodiment 1;

FIG. 22B is a view illustrating an example of priority processing capability tables according to Embodiment 1;

FIG. 22C is a view illustrating an example of processing capability tables according to Embodiment 1;

FIG. 23 is a view illustrating application to a system having different hardware configuration according to Embodiment 1;

FIG. 24 is a view illustrating data structure of document according to Embodiment 2;

FIG. 25A is a view illustrating storing structure of document according to Embodiment 2;

FIG. 25B is a view illustrating storing structure of document according to Embodiment 2;

FIG. 26 is a flow chart illustrating processing of document transfer and printing according to Embodiment 2; and

FIG. 27 is a view illustrating application to a system having different hardware configuration according to Embodiment 2.

### DESCRIPTION OF THE EMBODIMENTS

The best mode of carrying out the present invention will now be described with reference to the accompanying drawings.

### Embodiment 1

### Configuration of Image Processing Apparatus

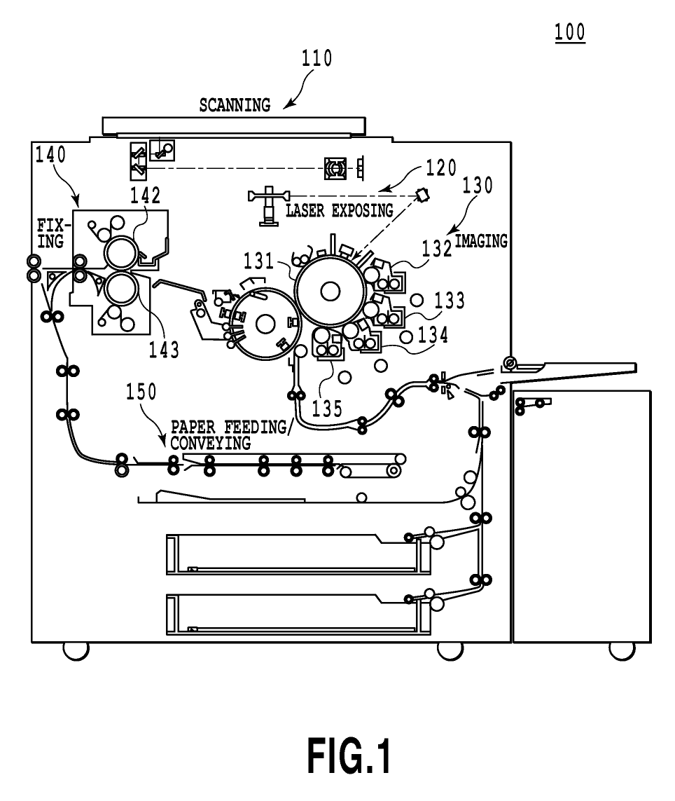

Configuration of a preferred embodiment of an image processing apparatus (Color MFP/Multi Function Peripheral) will be described with reference to FIG. 1.

The color MFP includes a scanning section 110, a laser exposing section 120, a photosensitive drum 131, an imaging section 130, a fixing section 140, a paper feeding/conveying section 150, and a printer control section (not shown) that controls these sections and the drum.

The scanning section 110 illuminates a manuscript placed on a platen, optically reads a manuscript image and converts the image into electric signals to generate image data.

The laser exposure section 120 causes a light beam such as a laser beam modulated in accordance with the image data to enter a rotary polygon mirror, and irradiates the photosensitive drum 131 with the reflection scanning light.

The imaging section 130 drives to rotate the photosensitive drum 131, charges it with a charger, develops a latent image formed on the photosensitive drum 131 by the laser exposure section 120 using toner, and transfers the resultant toner image onto a sheet. Further, the imaging section 130 executes a series of electrophotography processes such as collecting a small amount of toner that remains on the photosensitive drum 131 without being transferred, and forms images. On that occasion, while the sheet is wound around the predetermined position on a transfer drum and the drum rotates four times, respective developing units (developing stations) 132 to 135 that have magenta (M), cyan (C), yellow (Y) and black (B) toners, alternately, execute the above-mentioned electrophotography processes repeatedly. After four rotations, the sheet transferred with four-colored full-color toner image separates from the transfer drum and is conveyed to the fixing section 140.

The fixing section 140 includes a combination of rollers 142, 143 and belts, and incorporates a heat source such as a halogen heater. The fixing section 140 melts and fixes the toner on the sheet by heat and pressure, the sheet being transferred with the toner image by the imaging section 130.

The paper feeding/conveying section 150 has at least one sheet container as represented by a sheet cassette or a paper deck, separates a sheet from among a plurality of sheets stored in the sheet container in response to an instruction from the above described printer control section, and conveys the sheet to the imaging section 130/fixing section 140. The sheet is wound around the transfer drum at the imaging section 130 and conveyed to the fixing section 140 after four rotations. During four rotations, toner images of respective aforementioned colors of YMCK are transferred to the sheet. When images are formed on both surfaces of the sheet, the printer control section controls the sheet passed through the fixing section 140 so that it passes the conveying route for conveying the sheet to the imaging section 130 again.

The printer control section communicates with an MFP control unit (controller) that controls entire MFP 100, and executes a control in response to an instruction from the MFP control unit. The printer control section further checks a status of each of the aforementioned scanning section, laser exposing section, photosensitive drum, imaging section, fixing section and paper feeding/conveying section and instructs each of them so that the entire MFP 100 functions smoothly in line.

While FIG. 1 shows the color MFP with one photosensitive drum as an example, a four-drum color MFP of tandem type in which a photosensitive drum is arranged in parallel for each color of CMYK may be accepted.

### <System Configuration>

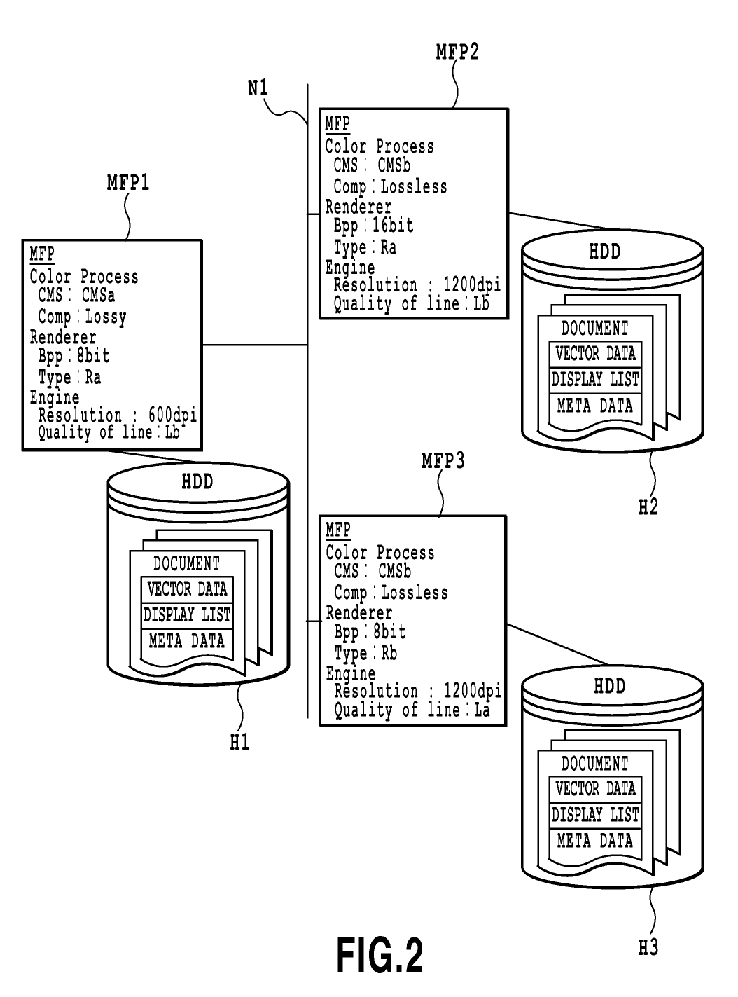

FIG. 2 is a block diagram illustrating the whole configuration of image processing system according to Embodiment 1. Referring to FIG. 2, the system includes image processing apparatuses MFP1, MFP2 and MFP3 that are connected each other via a network such as LAN (Local Area Network) N1.

The MFPs have HDDs (Hard Disk Drive: secondary storage) H1, H2, H3, respectively. Resolution of a printer engine (hereinafter “engine”) mounted on each MFP differs for each MFP, resolution of MFP1 and MFP3 is 600 dpi and that of MFP2 is 1200 dpi. A type and a tone of renderer (rasterizer) mounted in each MFP are different for each MFP. The renderers of MFP1 and MFP2 are the same type (in the figure, referred to as “Ra”), and the type of renderer of MFP3 is different from that of MFP1 and MFP2 (referred to as “Rb”). The gradation of image data processed by a renderer is 8 bits in MFP1 and MFP3, and is 16 bits in MFP2. In general, renderer is composed of hardware such as ASIC, thereby different types of renderer cannot process different type of render instruction groups. The render instruction group is referred to as “DisplayList” (hereinafter, referred to as “DL”). DL is an instruction capable of being processed by hardware and generated from vector data having complicated rendering description, and DL depends on resolution. Further, a type of color management system (CMS) and a compression process (Comp) method installed in the MFP are different for each MFP. Those of MFP2 and MFP3 are identical (CMSa, Lossless), and only that of MFP1 is different (CMSb, Lossy). These pieces of information are stored in H1 to H3 in each MFP and used for a generation of apparatus information, to be described later.

MFP1, MFP2 and MFP3 can communicate with each other using a network protocol. In addition, arrangement of these MFPs connected to the LAN N1 is not limited to above-mentioned physical arrangement. It may be possible that devices other than the MFP (for example personal computers, all sorts of servers, and printers) are connected on the LAN N1.

### <Control Unit Configuration>

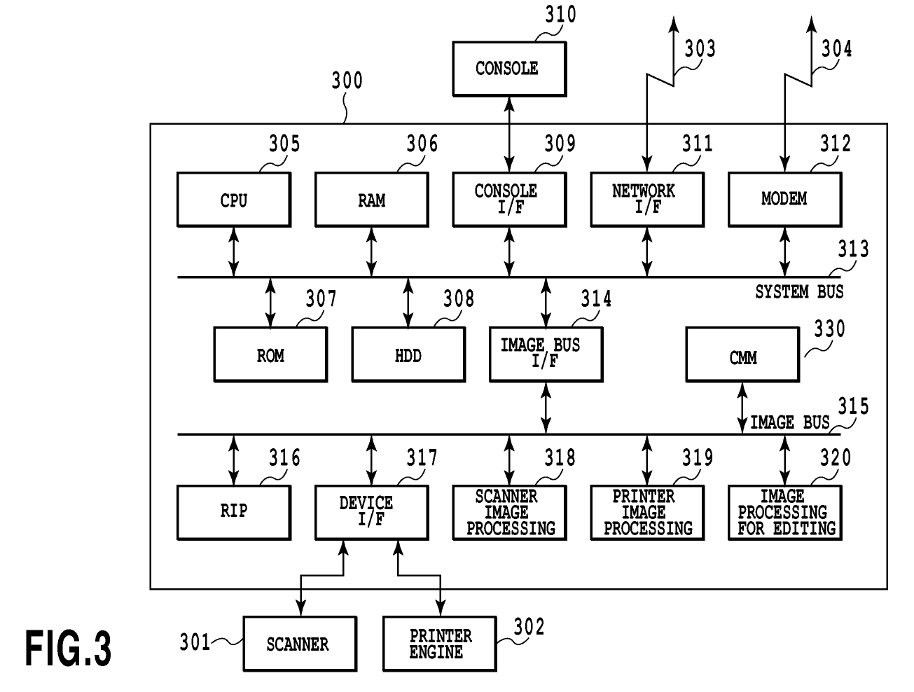

FIG. 3 is a block diagram illustrating a configuration of a control unit (controller) of the MFP according to Embodiment 1. In FIG. 3, a control unit 300 is connected to a scanner 301 that is an image input device of the color multi-functional machine and a printer engine 302 that is an image output device of the color multi function peripheral, and performs controls for reading image data and print output. Further, by connecting to LAN 303 and public network 304, the control unit 300 performs controls for input/output of image information and device information via LAN 303.

The scanner 301 corresponds to the scanning section 110 and the printer engine 302 corresponds to the sections 120 through 150.

A CPU 305 is a central processing unit to control the entire MFP. A RAM 306 is a system work memory with which the CPU 305 functions as well as being an image memory for temporarily storing input image data. A ROM 307 is a boot ROM that stores boot program of the system. An HDD 308 is a hard disk drive that stores system software for various processing and input image data. A console I/F 309 is an interface section for a console 310 that has a display screen capable of displaying image data etc., and outputs operation screen data to the console 310. The console I/F 309 transmits information to the CPU 305, which is input by an operator at the console 310. A network interface 311 is implemented by, for example, a LAN card, and performs input/output of information from/to an external apparatus by connecting to LAN 303. A modem 312 is connected to the public network 304, and performs input/output of information from/to an external apparatus. The above units are connected via a system bus 313.

An image bus I/F 314 is an interface for connection between the system bus 313 and an image bus 315 that transfers image data at a high speed, and is a bus bridge that converts data structure. Onto the image bus 315, there are connected a raster image processor 316, a device I/F 317, a scanner image processing section 318, a printer image processing section 319, an image processing section for image editing 320 and a color management module (CMM) 330.

The raster image processor (RIP) 316 expands page description language (PDL) code and vector data described below to an image. The device I/F section 317 connects the scanner 301 and the printer engine 302 to the control 300, and converts between synchronous image data and asynchronous image data.

The scanner image processing section 318 performs various processing such as correction, modification, and editing on image data input from the scanner 301. The printer image processing section 319 performs processing such as correction depending on the printer engine, and resolution conversion on image data to be print output. The image processing section for image editing 320 performs processing such as rotation of image data, and compression elongation processing of image data. The color management module (CMM) 330 is a dedicated hardware module that executes color conversion processing (in other word, color space conversion processing) based on profile and calibration data on image data. Profile is information like a function by which color image data represented by device-dependent color space is converted to device-independent color space (for example, Lab). Calibration data is data by which color reproduction characteristics at the scanner 301 and the printer engine 302 in the MFP 100 is corrected.

### <Controller Software Configuration>

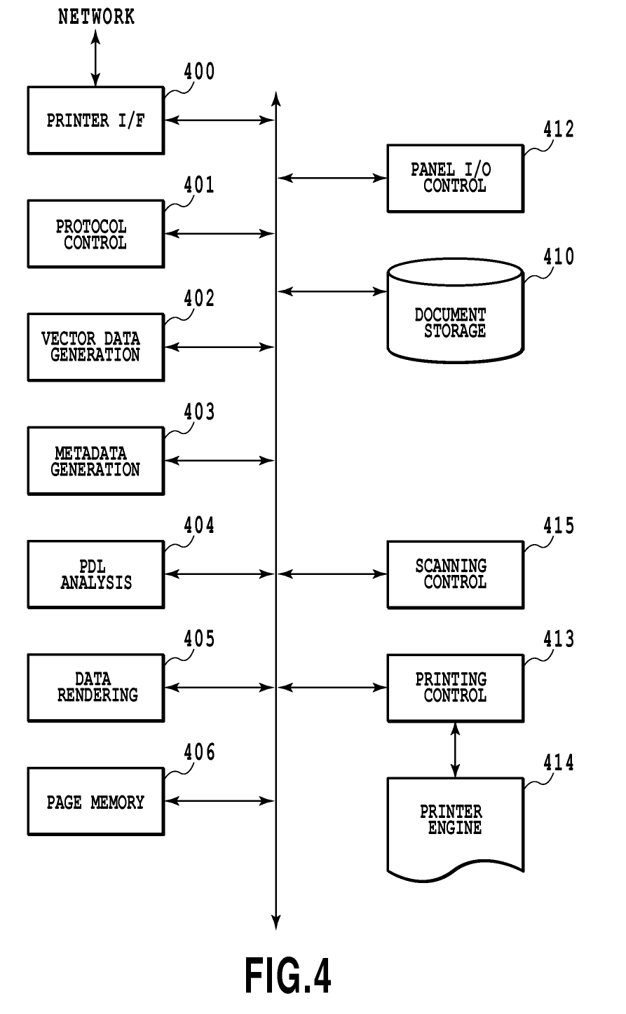

FIG. 4 is a block diagram illustrating a configuration of controller software that controls operation of MFP. The controller software depicts FIG. 3 using function blocks.

A printer interface 400 performs input/output from/to outside. A protocol control section 401 communicates with outside by analyzing and transmitting network protocols.

A vector data generation section 402 generates (vectorizes) resolution-independent vector data that is render description from a bit map image (raster image data).

A metadata generation section 403 generates subsidiary information obtained during the vectorization process as metadata. Metadata is data such as additional data for searching not necessary for rendering processing.

A PDL analyzing section 404 analyzes PDL and converts it to intermediate codes (DisplayList; denominated below “DL”) whose format is easier to process. The intermediate codes generated at PDL analyzing section 404 is handed over to a data rendering section 405 and is processed. The data rendering section 405 expands aforementioned intermediate codes to bit map data. The expanded bit map data is rendered on a page memory 406 sequentially.

The page memory 406 is a volatile memory that temporarily holds bit map data expanded by the data rendering section 405 or a renderer.

The panel input/output control section controls input/output from an operating panel.

A document storing section 410 stores data file including vector data, DL and metadata for each job unit of input document. The document storing section 410 is implemented by secondary storage such as a hard disk drive. In the present embodiment, the data file is referred to as “Document”.

A Scanner control section 415 performs various processing such as correction, modification and editing on image data input from the scanner.

A printing control section 413 performs conversion of contents on the page memory 406 to video signals, and then transfers image to a printer engine section 414. The printer engine section 414 corresponding to the above described printer engine 302 is a printer mechanical section for forming a permanent visible image on a recording paper based on the received video signals.

### <Data Processing of Controller Unit>

Next, how vector data, DL and metadata which compose Document are generated will be described.

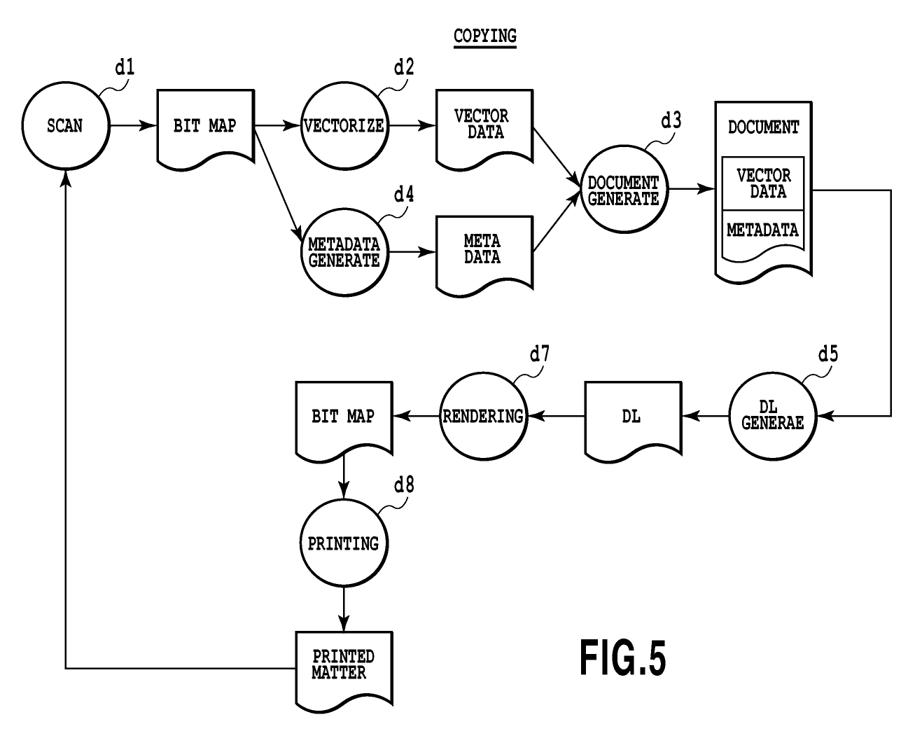

FIGS. 5, 6 and 8 illustrate data flows at a controller unit according to Embodiment 1.

FIG. 5 is a data flow during copying.

First, a paper manuscript set at the scanner section 100 is converted to bit map data by scanning process d1. Next, by vectorizing process d2 and metadata generation process d4, resolution-independent vector data and accompanying metadata are generated from the bit map data. Specific generation method of vector data and metadata will be described later.

Next, by Document generation process d3, Document in which the vector data and the metadata are associated is generated. Then, by DL generating process d5, DL is generated from the vector data in the Document, and the generated DL is stored in the Document as well as being sent to rendering processing d7 to be expanded to bit map.

The expanded bit map is recorded on a paper medium to be a publication by printing processing d8. It may be possible to start processing from scanning processing d1 when the output publication is again set at scanning section 100.

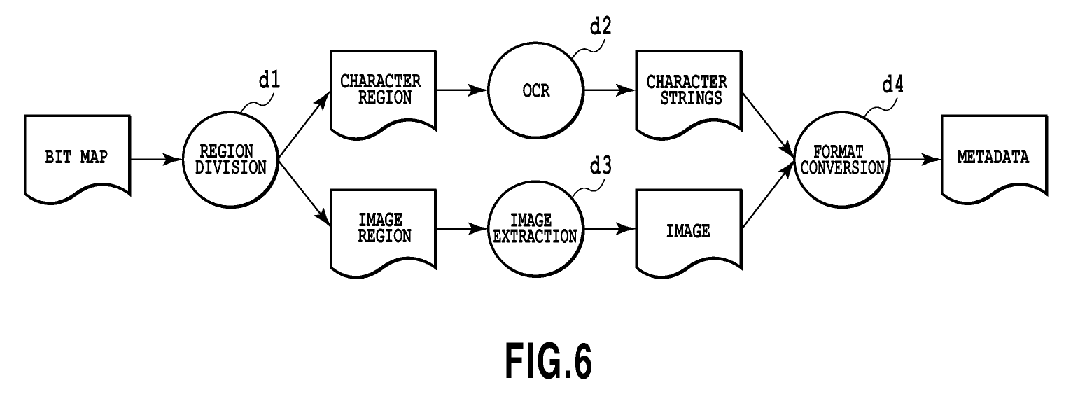

FIG. 6 illustrates specific data flow of metadata generation processing d4 shown in FIG. 5.

First, at region division processing d1, a bit map is region divided.

Region division is processing that analyzes input bit map image data, divides the data into regions at a block of objects, and determine attribute of each region to classify the regions. The type of the attributes includes characters (TEXT), images (PHOTO), lines (LINE), graphic symbol (PICTURE), tables (TABLE) and so on.

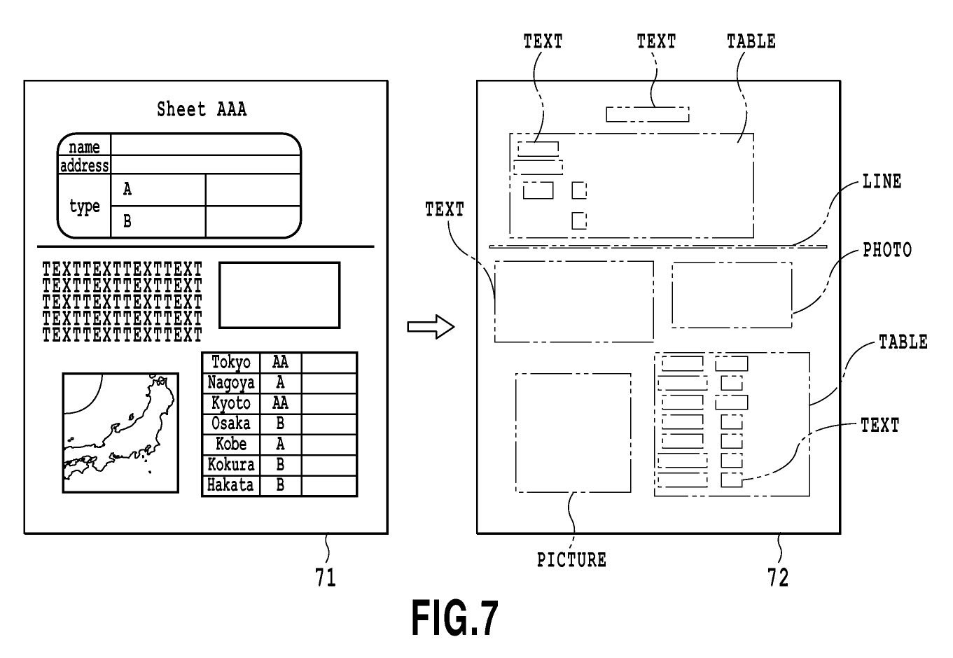

FIG. 7 illustrates an example of region division on an input image. A result of the region division on input image 71 is determination result 72. In the determination result 72, a portion enclosed by a dashed line represents a unit of objects as a result of image analyzing and a kind of attribute attached to each of the objects is a determination result of the region division.

From among the regions classified for each attribute, a region having “TEXT” attribute is converted to character strings by character recognition processing at OCR processing d2. Thus, the character string is a character string that will be printed on a paper.

From among the regions classified for each attribute, a region having “PICTURE” attribute is converted to image information by image information extraction processing d3. The image information is character strings that depict characteristic of the image, for example, a character string such as “flower” or “face”. For the image information extraction, it may be possible to use a commonly used image processing technique such as detection of image characteristic quantity (such as a frequency and a density of pixels composing an image) and face recognition.

Formatting the generated character strings and image information to a data format described below at format conversion processing d4 generates metadata.

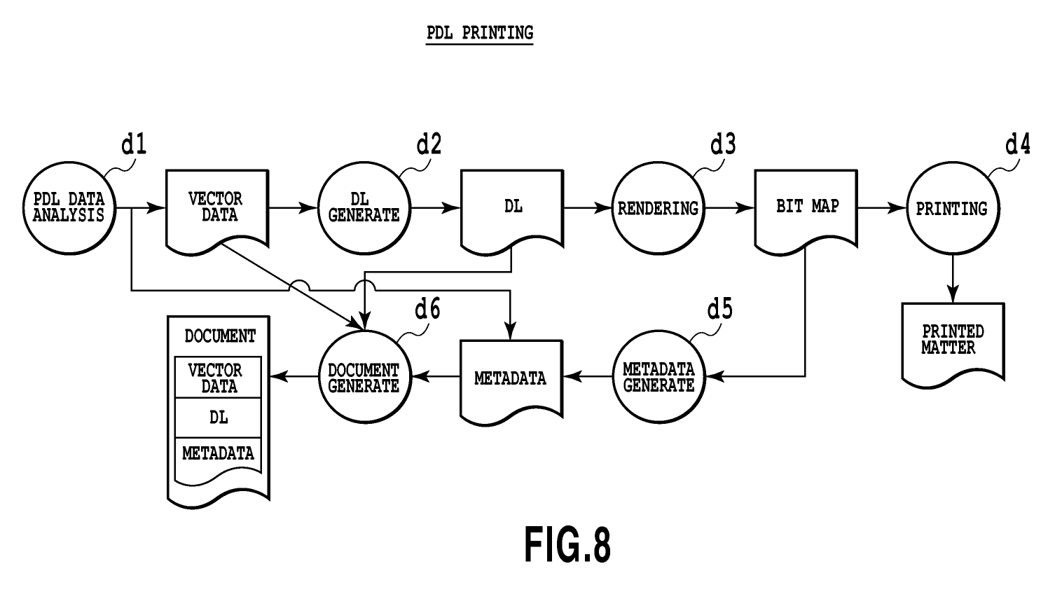

FIG. 8 illustrates a data flow during PDL (Page Description Language) printing. The PDL printing is a printing function on which page description language (PDL) generated by a printer driver on a PC (Personal Computer) is received and print out when application software on the PC instructs printing.

First, received PDL data is analyzed by PDL data analyzing processing d1, and thereby vector data is generated.

Next, DL is generated by DL generating processing d2 from vector data. The generated DL is stored in the Document and sent to rendering processing d3 to be expanded to a bit map. The expanded bit map is recorded on a paper medium to be a printed matter by printing processing d4.

Vector data and DL generated during the course of these processing is stored in the Document at Document generation processing d6.

Further, character strings and image information are generated as metadata from the bit map generated at rendering processing d3 in the same manner as copying at metadata generating processing d5 described in FIG. 6, and stored in the Document.

A wide variety of PDL such as LIPS (LBP Image Processing System) (Registered trade mark) and PS (PostScript) (Registered trade mark) exists. Some PDL have information of character strings. In the case of PDL having information of character strings, at PDL analyzing, metadata is generated from character strings and stored in the Document.

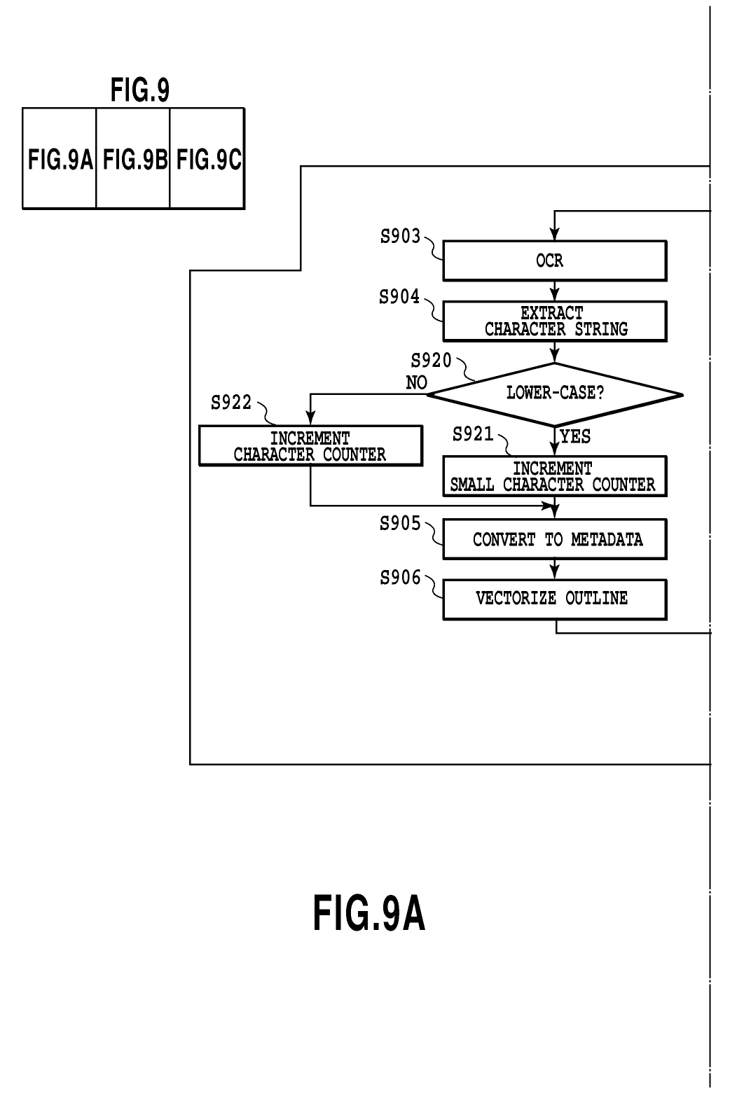

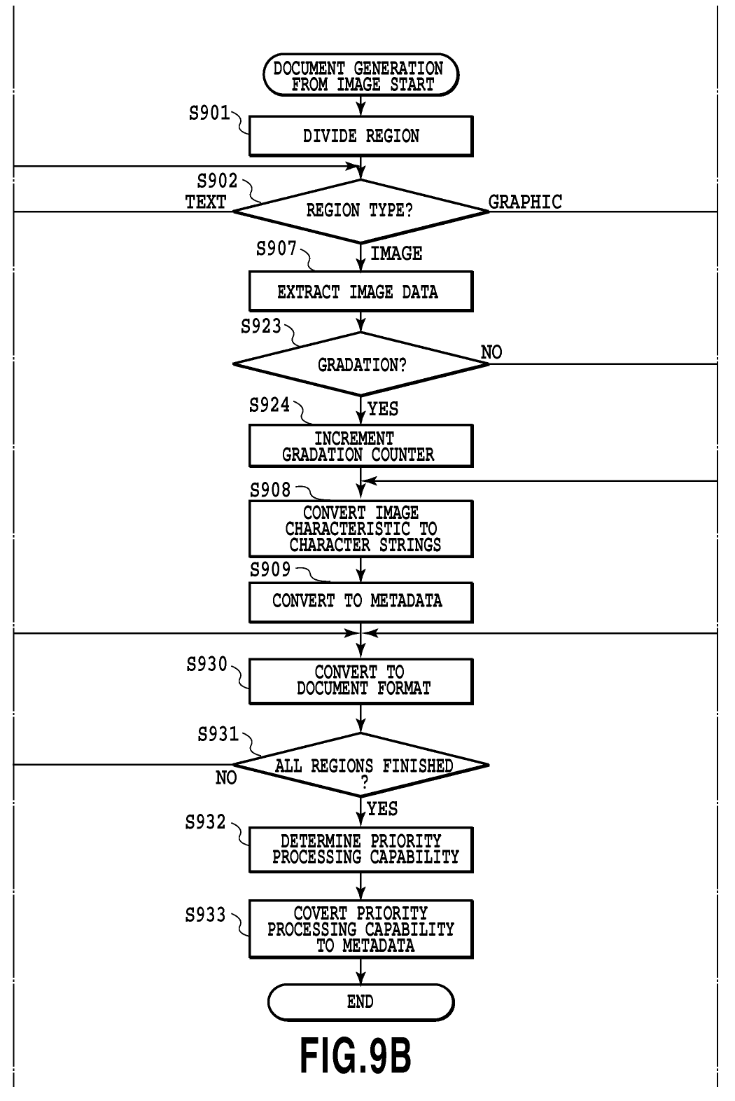

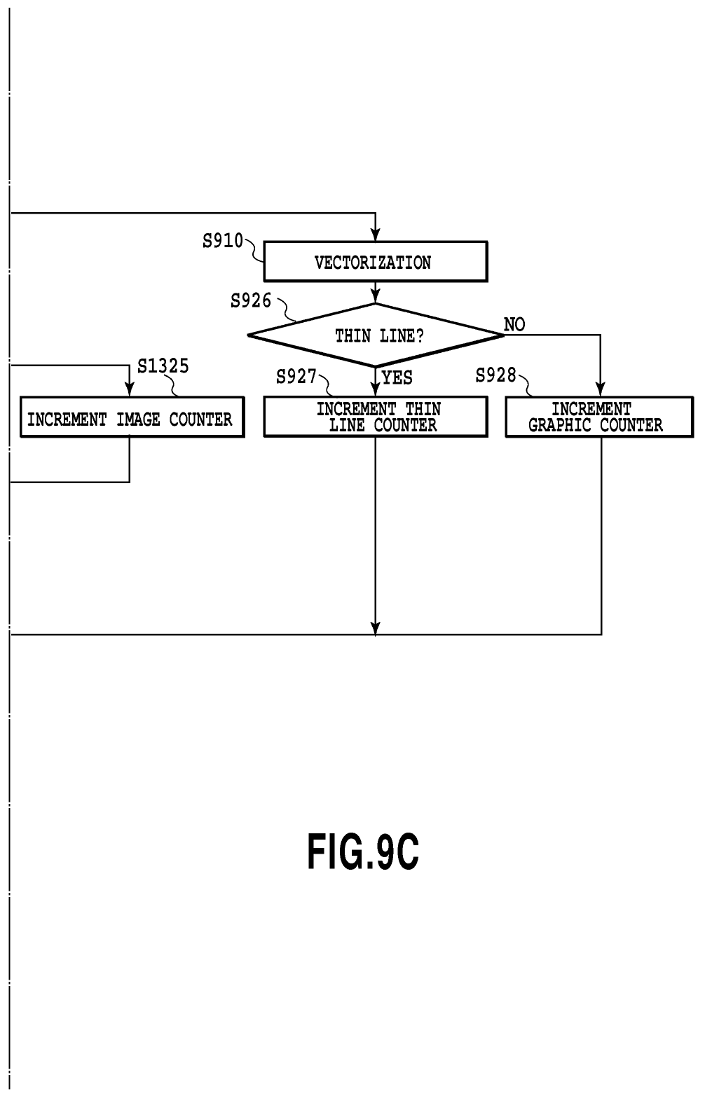

Next, Document generation processing in the controller unit will be described with reference to the flow chat in FIGS. 9A, 9B and 9C.

The flow chart illustrates Document generation processing for a bitmap obtained by scanning. The processing is processing that generates Document composed of vector data and metadata from bit map data.

First, in step S901, aforementioned region division processing is performed. Next, a class (attribute) of region is classified into TEXT, GRAPHIC, or IMAGE in step S902. Different processing is performed on each of the classified regions. In FIG. 7, a case where attribute is classified into “TEXT”, “PHOTO”, “LINE”, “PICTURE” and “TABLE” is illustrated. Here, among the attributes in FIG. 7, “PHOTO” and “PICTURE” are merged into “IMAGE”, and “LINE” and “TABLE” are merged into “GRAPHIC”.

When the attribute of the region is “TEXT”, the flow proceeds to step S903 and OCR processing is performed, and then in step S904, extracting of character strings is performed. In step S920, determination whether the extracted character is smaller than a certain size is performed. When determination that the extracted character is of the smaller size is made in step S920, a small character counter is incremented in step S921. When determination that the extracted character is out of the smaller size is made, a character counter is incremented in step S922. After the processing, character strings are converted to metadata in step S905, and the flow proceeds to step S906 where the recognized character outline is converted to vector data.

Here, an additional description is provided. Metadata generated from character strings is a list of character codes, which is necessary information for keyword searching.

In OCR processing, a character code can be recognized, however, font type such as “Mincho” or “Gothic”, character size such as “10 pt” or “12 pt”, and character decoration such as “Italic” or “Bold” cannot be recognized. Therefore, rendering needs to retain a character outline as vector data instead of using character codes.

In step 902, when an attribute of the region is “IMAGE”, the flow proceeds to step S907 and image information extracting processing is performed.

As previously mentioned, in step S907, a characteristic of the image is detected using a commonly used image processing technique such as detection of image characteristic quantity and face recognition. Based on the detected characteristic, in step S923, whether the image is gradation or not is determined. When determination that the image is gradation is made, a gradation counter is incremented in step S924. When determination that the image is not gradation is made, an image counter is incremented in step S925. Next the flow proceeds step S908, the detected characteristic of the image is converted to a character string. The conversion becomes easier when a table of a characteristic parameter and a character string is retained.

After that, in step S909, the character string is converted to metadata.

When an attribute of a region is “IMAGE”, vectorization of the image is not performed, and the image data is retained in vector data as it is.

When an attribute of a region is “GRAPHIC” in step S902, the flow precedes step S910. In step S910, vectorization of the image is performed. In step S926, whether the image is a thin line or not is determined by a width of the line and a distance between edges on the same scanning line. When determination that the image is a thin line is made, a thin line counter is incremented in step S927. When determination that the image is not a thin line is made, a graphic counter is incremented in step S928. Each of the counters described above is incremented by a number of data and size of a region.

Above “TEXT”, “GRAPHIC” and “IMAGE” data is converted to Document format in step S930. Until an end of processing on all regions is detected in step S931, steps from step S902 to step S930 are executed repeatedly.

When processing on all regions is finished, in step S932, priority processing capability, more specifically, priority is determined from attributes of the biggest and the second biggest counter values using priority processing capability table described below. In step S933, priority processing capability retrieved from the priority processing capability table is converted to metadata and added to the Document.

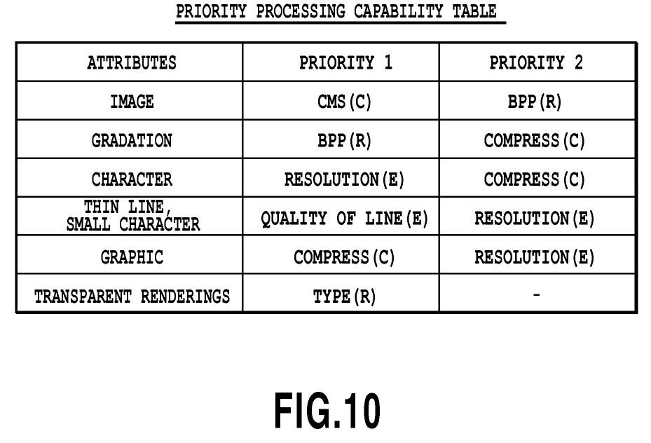

FIG. 10 illustrates a priority processing table for each of attributes stored in ROM 207 of the controller unit.

In the priority processing capability table retained are a first priority processing capability and a second priority processing capability in advance for each of attributes of region. The priority processing capabilities include a type of color matching (CMS), a compression method (Compress), processing tone (BPP), type of rendering (Type), output resolution (Resolution) and thin line reproduction (Quality of line). These priority processing capabilities are classified into three of; conversion processing (Color Process), renderer (Renderer) and engine (Engine). The conversion processing is classified into color matching and compression format. The renderer is classified into processing tone and rendering method. The engine is classified into output resolution and thin line reproduction. In the case of “IMAGE”, the first priority is the color matching, and the second priority is the tone. A character in parenthesis indicates processing classification; C, R and E represent the conversion processing, the renderer and the engine, respectively. It may be possible that the priority processing capability includes any processing that is performed in the image processing apparatus. In step S933, the data is converted into metadata in a sequence that is determined in accordance with the priority processing capabilities 1 and 2 of the first attribute of the data and the priority processing capabilities 1 and 2 of the second attribute of the data. In the present embodiment, the number of the priority processing capabilities is set to four. However, it may be possible to change the number to one or any.

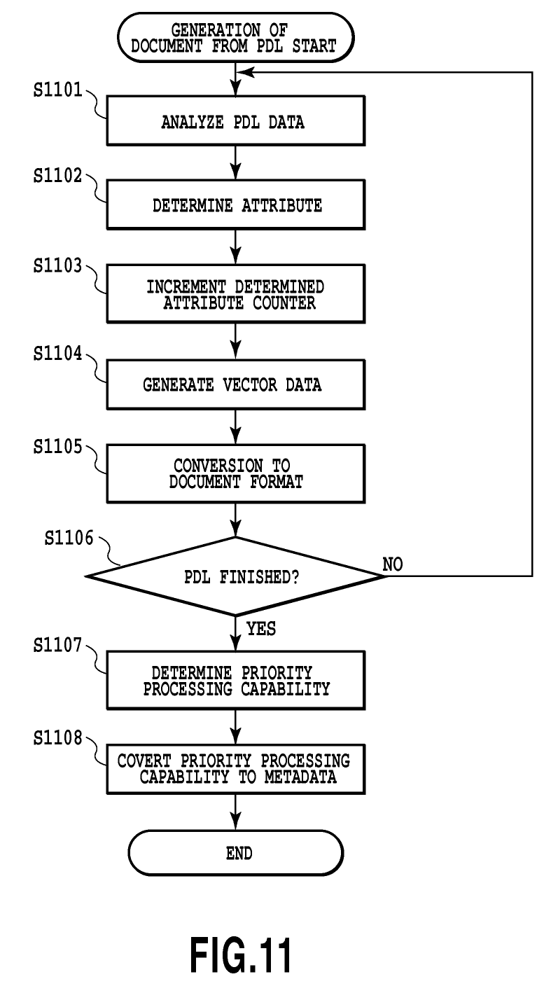

FIG. 11 is a flow chart of Document generation processing from PDL. The processing is processing at which a controller unit receives PDL data and generates Document.

First, in step S1101, PDL data is analyzed. During the analysis, in step S1102, attributes such as “TEXT”, “GRAPHIC” and “IMAGE” are determined. In step 1403, each of the abovementioned counters is incremented in accordance with the determined attributes. Next, in step S1104, the data is converted to vector data. The flow proceeds to step S1105, and Document is generated. Until an end of the PDL data is detected in step S1106, steps from step S11001 to step S1105 are processed repeatedly.

In step S1107, priority processing capability is determined from attributes of the biggest and the second biggest counter values using the priority processing capability table. That is, the highest priority processing of the attribute of the biggest counter is the highest priority processing capability and the second priority processing of the attribute of the biggest counter is the second priority processing capability. In the same manner, the highest priority processing of the attribute of the second biggest counter is the third priority processing capability and the second priority processing of the attribute of the second biggest counter is the fourth priority processing capability. In step S1108, the priority processing capability obtained from the priority processing capability table is converted to metadata. A detail of step S1108 is identical to that of step S933.

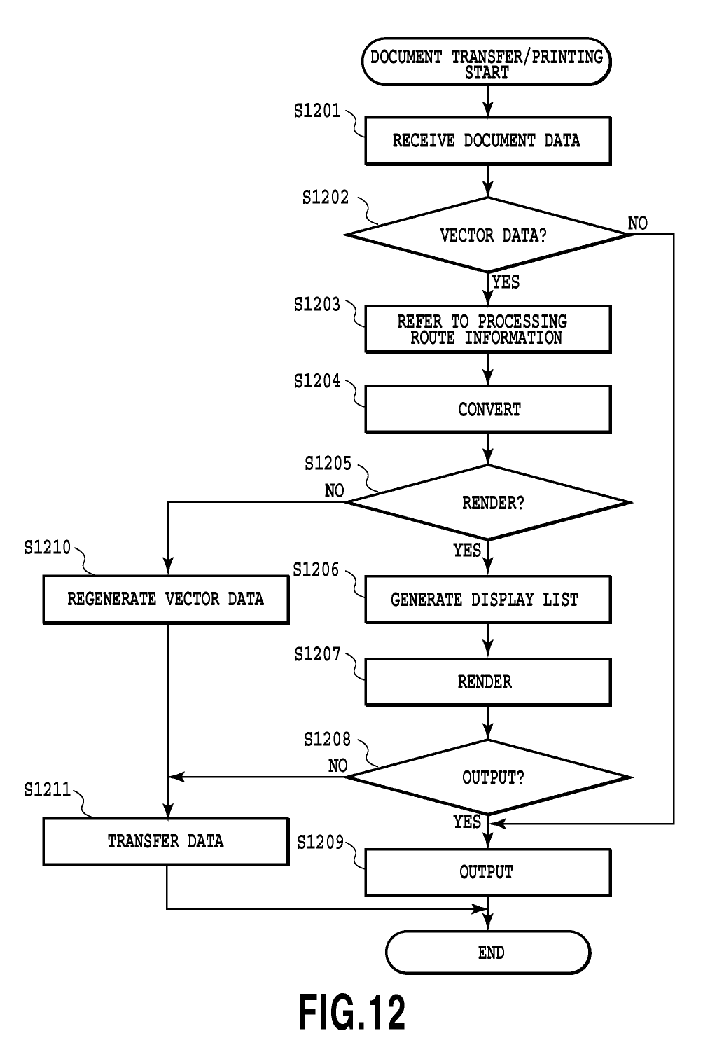

FIG. 12 is a flow chart illustrating processing of transferring or printing Document. The processing is processing either transferring the generated Document to other image processing apparatus or processing to print out the generated Document. In the processing in FIG. 12, Document is processed by selectively using the conversion processing (color process), renderer, and engine in a plurality of the MFPs via the plurality of the MFPs in accordance with processing route information, to be described later.

In step S1201, the Document data is received, and in step S1202, whether received Document is vector data or not is determined. When the determination result is vector data, in step S1203, the Document data and processing route data (described below) received at the same time are referred to. In step S1204, conversion processing (color process) is performed in accordance with the processing route information. Next, in step S1205, referring to the processing route information, whether rendering processing is performed or not is determined. As a result of the determination, when rendering is performed, DisplayList is generated in step S1206 and rendering is performed in step S1207.

Next, in step S1208, whether output process referring to the processing route information is to be performed or not is determined. As a result of the determination, when output process is to be performed, the output process is performed in step S1209.

When in step S1205 rendering processing is not performed, in step S1210 vector data is regenerated. Following the processing, in step S1211, vector data or bit map data is transferred to other image processing apparatus in accordance with the processing route information. Even though output processing is not performed in accordance with the determination in step S1208, in step 1211, transfer processing is performed.

### <Structure of Document Data>

Next, structure of Document data will be described.

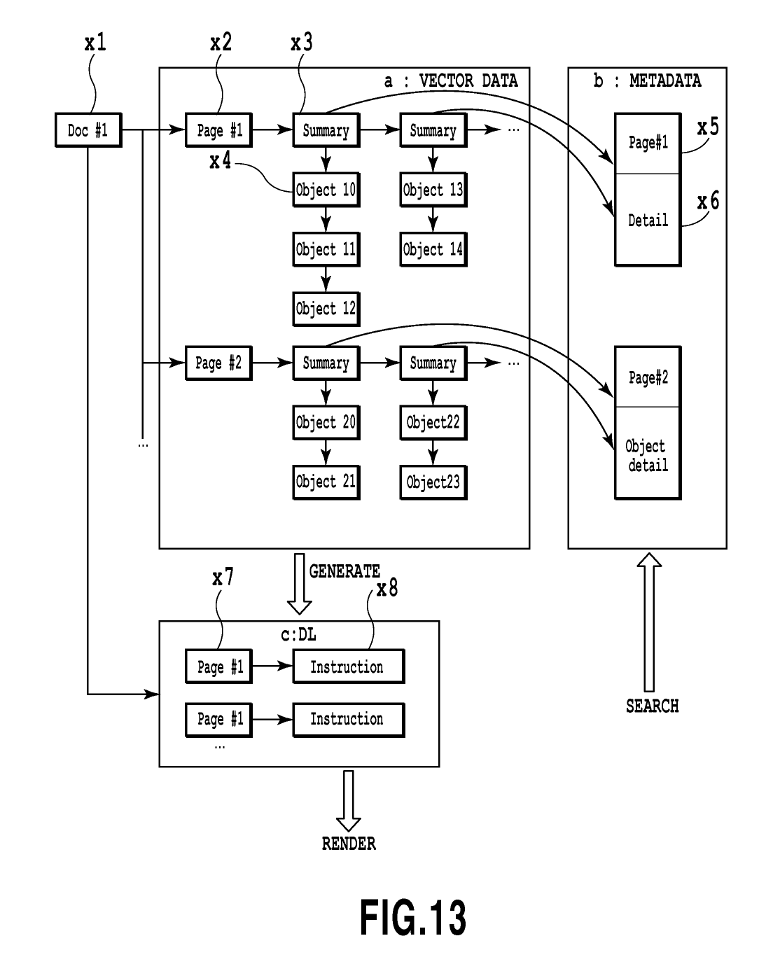

FIG. 13 illustrates data structure of Document.

Document is data having a plurality of pages, and mainly composed of vector data (a), metadata (b) and DL (c). Document has hierarchical structure in which Document header (x1) stands at the forefront. Vector data (a) is composed of page header (x2), summary information (x3) and objects (x5). The metadata (b) is composed of page information (x5) and detailed information (x6). DL (c) is composed of page header (x7) and instructions for rendering expansion (x8). Document header (x1) is described with the vector data storing position and DL storing position. Thus the vector data and DL are associated with Document header (x1).

Vector data (a) is resolution-independent rendering data. Therefore layout information such as size of a page and direction page is described on header (x2). Rendering data such as line, polygon and Bézier Curve is linked to object (x4) one by one. A plurality of objects is collectively linked to summary information (x3). Summary information (x3) depicts characters of a plurality of objects as a whole. Attribute information of divided regions explained in FIG. 7 and the like is described in summary information (x3).

Metadata (b) is additional information data for searching that is not relevant to rendering output processing. Page information such as information whether the metadata is generated from, for example, bit map data or from PDL data is described in a region of page information (x5). OCR information and character strings (character code set) are described in detailed information (x6).

Summary information (x3) in vector data (a) refers metadata (b), thereby finding detailed information (x6) from summary information (x3).

DL (c) is an intermediate code for bit map expansion by renderer. Management table of rendering information (instruction) in the pages and the like is described in page header (x7). Instruction (x8) is composed of resolution-dependent rendering information.

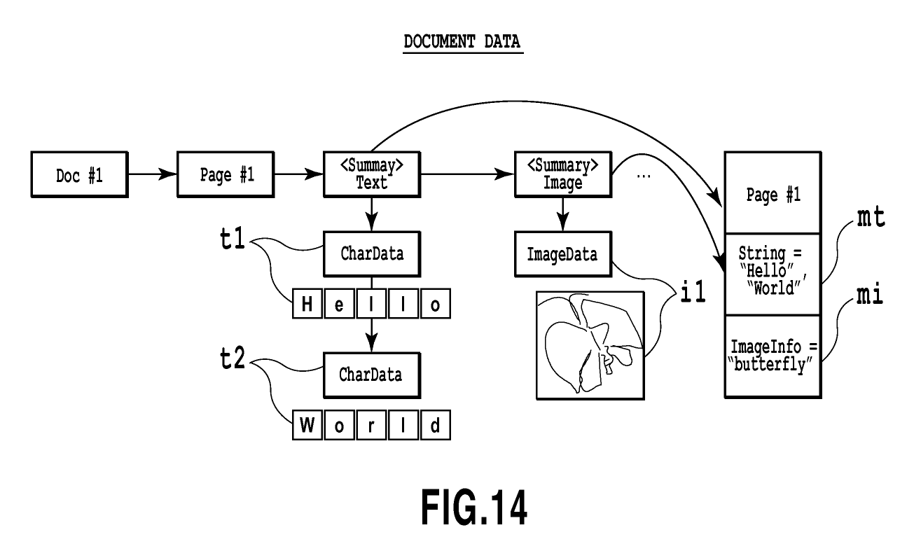

FIG. 14 illustrates a specific example of Document data.

The data has “TEXT” and “IMAGE” at summary information in page 1. Character outlines of “H”, “e”, “l”, “l”, “o” (object t1) and “W”, “o”, “r”, “l”, “d” (object t2) are linked to summary information of “TEXT” as vector data.

The summary information refers to character code sets (metadata mt) as “Hello” and “World”.

A photo image (JPEG) of butterfly is linked to summary information of “IMAGE”. The summary information refers to image information (metadata mi) as “butterfly”.

Consequently, for example, when text searching is performed using a keyword of “World”, a searching flow below can be used. First, vector page data is retrieved from the Document header sequentially. Then metadata linked to “TEXT” is searched by summary information that is linked to a page header.

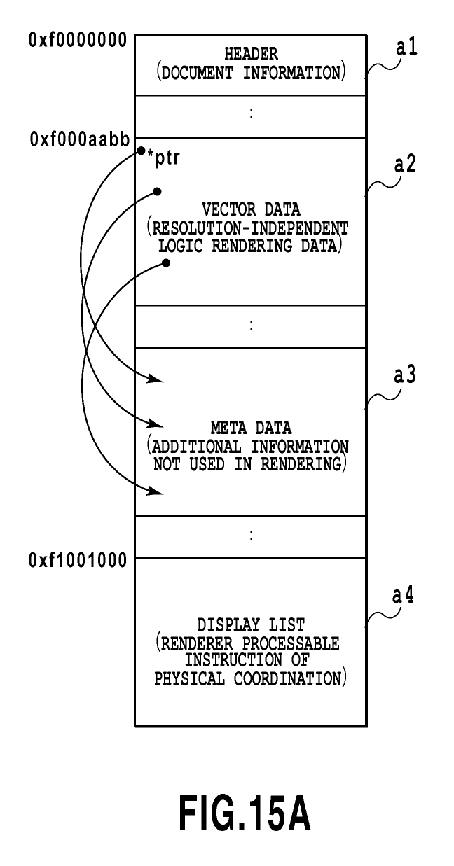

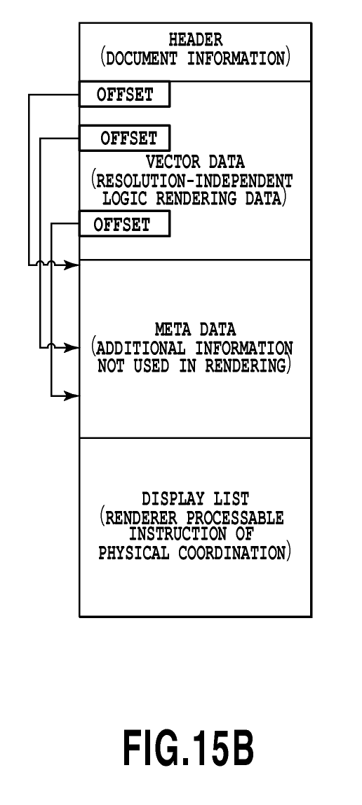

FIG. 15A is a diagram illustrating how the data structure explained in FIG. 13 is located on a memory. FIG. 15B is a diagram illustrating how the data structure explained in FIG. 13 is located on a file.

As shown in FIG. 15A, vector data region (a1), metadata region (a2) and DL region (a3) of Document are located in any address on the memory.

As shown in FIG. 15B, vector data region (a1), metadata region (a2) and DL region (a3) of Document are serialized in a file.

### <Box Printing Processing>

Next, Box printing processing according to the present embodiment will be described. Box function is a function on which manuscript images scanned at MFPL and PDL data sent from an external PC are temporarily accumulated in a secondary memory apparatus such as an HDD 208 without printing, for example.

By the Box function, when an user intends to reprint out data that has already been printed out, the user can do so by selecting desired data at UI and the like without scanning the data again or sending the data from a PC again. Therefore, the BOX function allows saving many steps. In the present embodiment, processing in which accumulated data is retrieved from the HDD 208 and printed by the BOX function is referred to as “Box Print”.

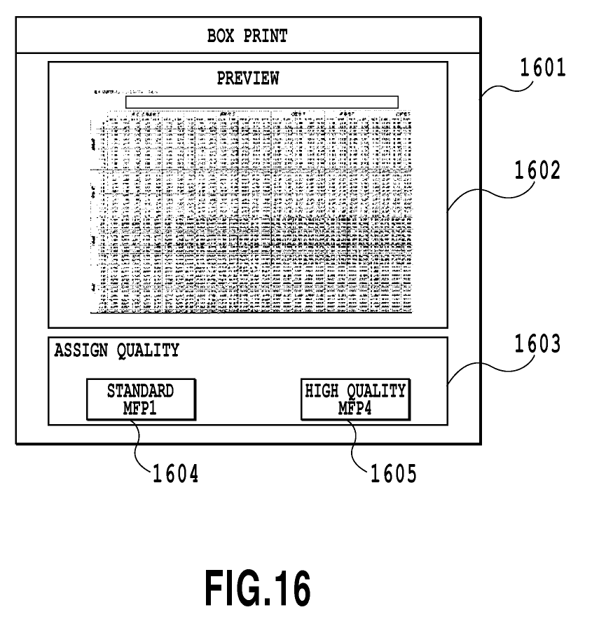

FIG. 16 is an example of a screen that is displayed by a display section of console for Box Print. Screen 1601 for implementing Box Print operation is displayed on the operating section, when a user (operator) selects Box Print execution.

When an operator selects data in a BOX using searching function and the like such as keyword searching in a multifunction peripheral (MFP), an image of an output result to confirm whether the result is identical to the data that the operator desires is displayed on pre-view display screen 1602. Hitting standard button 1604 or high quality button 1605 on image quality assigning screen 1603 by a user starts output of the selected data. A name of multifunction peripheral on which data is printed out is displayed on standard button 1604 or high quality button 1605.

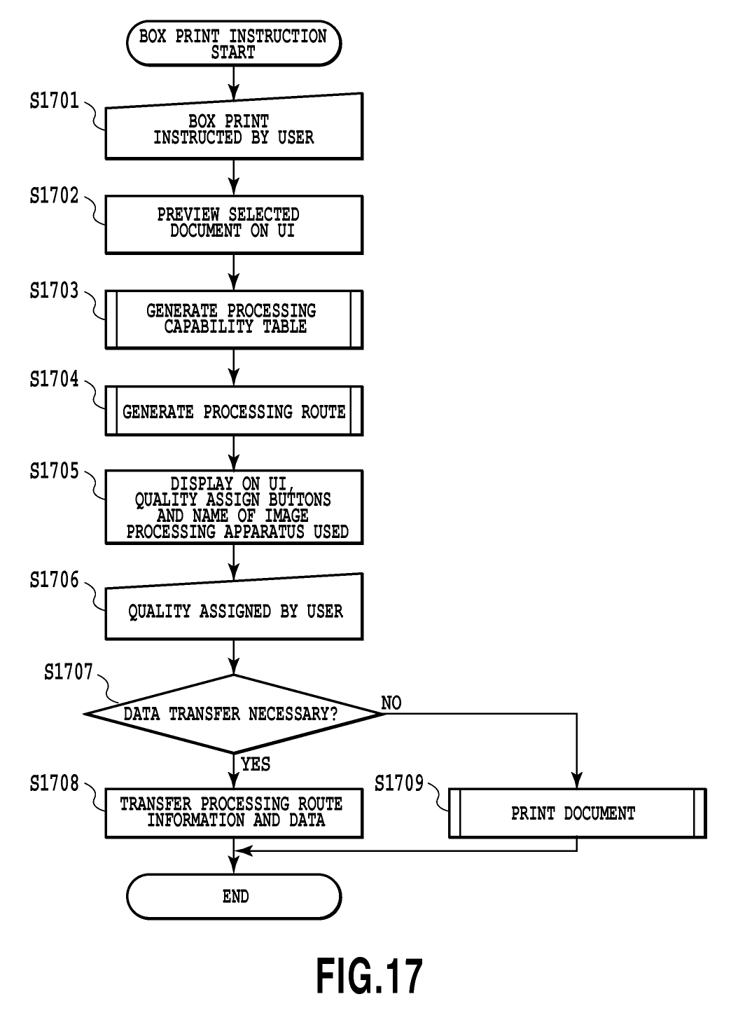

Next, processing of Box Print instruction according to the present embodiment will be described with a reference to a flow chat in FIG. 17.

In step S1701, selecting Box Print execution by a user (operator) from the console 310 makes an instruction for Box Print.

In step S1702, a pre-view image of Document data selected from a BOX by a user is displayed on the pre-view display screen 1602.

In step S1703, a processing capability table of each device (MFP) on the network is generated. A detail of “processing capability table generation” processing will be described later.

The flow proceeds to step S1704. In step S1704, the above described processing route information is generated for the selected Document data. A detail of “processing route generation” processing will be described later. In step S1705, a name of multifunction peripheral (MFP) selected by processing route generation processing on image quality assigning screen 1603 to output the Document data is displayed on standard button 1604 or high quality button 1605.

In step S1706, hitting a button displayed on image quality assigning screen 1603 by the operator selects output image quality. In step S1707, a processing route that corresponds to the image quality selected by the operator is referred to. As a result of the referring to in step S1707, in case that it is necessary to transfer the data to external devices, processing route information and data are transferred in step S1708. In case (standard case) that it is unnecessary to transfer the data to external devices, printing processing of the Document explained in FIG. 12 is performed by one MFP in step S1709.

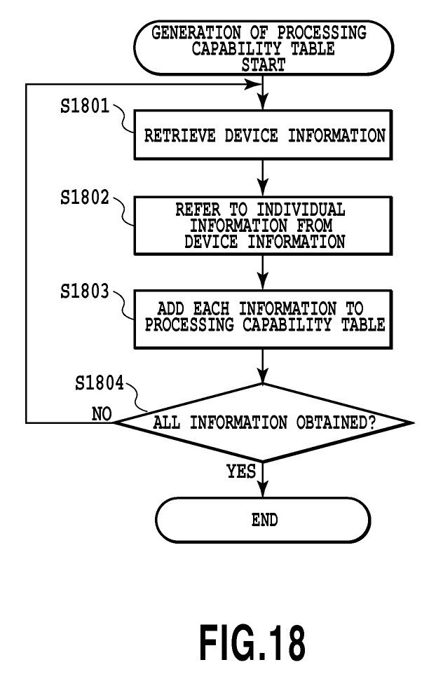

Next, a processing capability table generating flow described in step S1703 will be described with a reference to a flow chat in FIG. 18. The processing is processing to retain processing capability of each device as a table.

In step S1801, apparatus information of each external MFPs is obtained via network. In step S1802, color matching, compression format, processing tone, rendering method, output resolution and thin line reproduction that are included in the obtained apparatus information are referred to.

In step S1803, each of the referred information is added to aforementioned processing capability table.

Until obtaining apparatus information from all external devices connected to the network is detected in step 1804, steps from step S1801 to step S1803 are executed repeatedly.

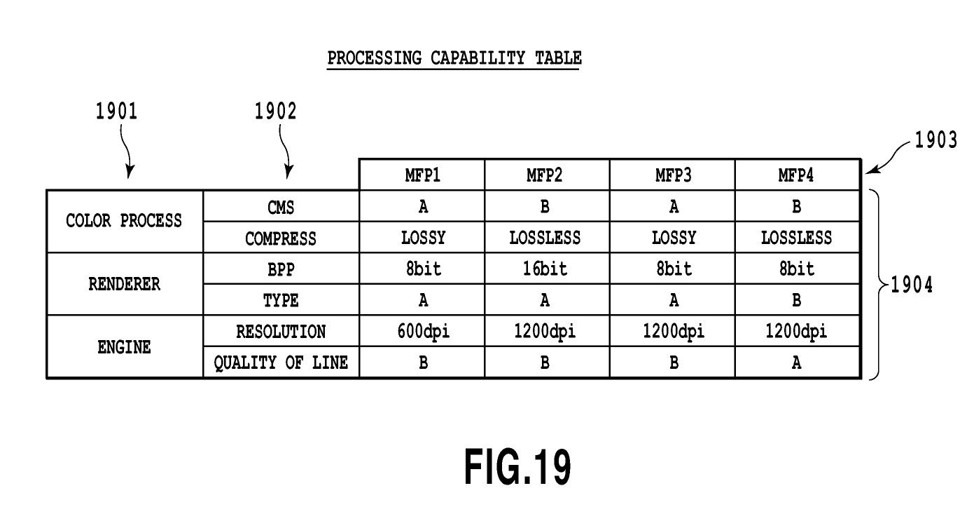

FIG. 19 illustrates an example of a processing capability table generated by the processing capability table generating flow.

Reference numeral 1902 depicts processing contents in which each device has different capability. The processing contents include color matching, compression format, processing tone, rendering method, output resolution and thin line reproduction. Each of the processing contents is explained in FIG. 10.

Reference numeral 1901 depicts processing classification with respect to the processing content. Conversion processing (Color Process) is executed when color matching processing and compress processing on a generated document are performed. The conversion processing includes CMS and Compress. Renderer (Renderer) is processing that converts Document to bit map. The renderer includes BPP and Type.

Reference numeral 1903 depicts name of device. Name of device is a name peculiarly allocated to each apparatus, and is obtained from apparatus information fetched using communication apparatus such as network.

Reference numeral 1904 depicts processing capability. The processing capability is obtained from the device information as the same manner as aforementioned name of device. Processing capability of CMS involves high-accuracy CMS (A) and (B) that performs color matching by 8-bit data using ICC profile, conventional CMS. The high-accuracy CMS (A) performs image processing using extended color space (for example, ScRGB) as well as color matching using CIECAM02 regarding observation environment by 16-bit image data. Processing capability of Compress is classified into Lossy (for example, JPEG) meaning existence of image deterioration and Lossless (for example, LosslessJPEG, JPEG2000) meaning none of image deterioration or less image deterioration. Processing capability of BPP involves 8 bits, 16 bits and the like. Processing capability of Type is classified into half-tone renderer that could cause image deterioration at alpha blend and ROP (Raster Operation Process) and the like (A) and full-color renderer. Processing capability of Resolution involves 600 DPI, 1200 DPI and the like. Processing capability of Quality of line involves existence or nonexistence of correlation processing for curbing a j aggy generation at an edge of a line, and the like.

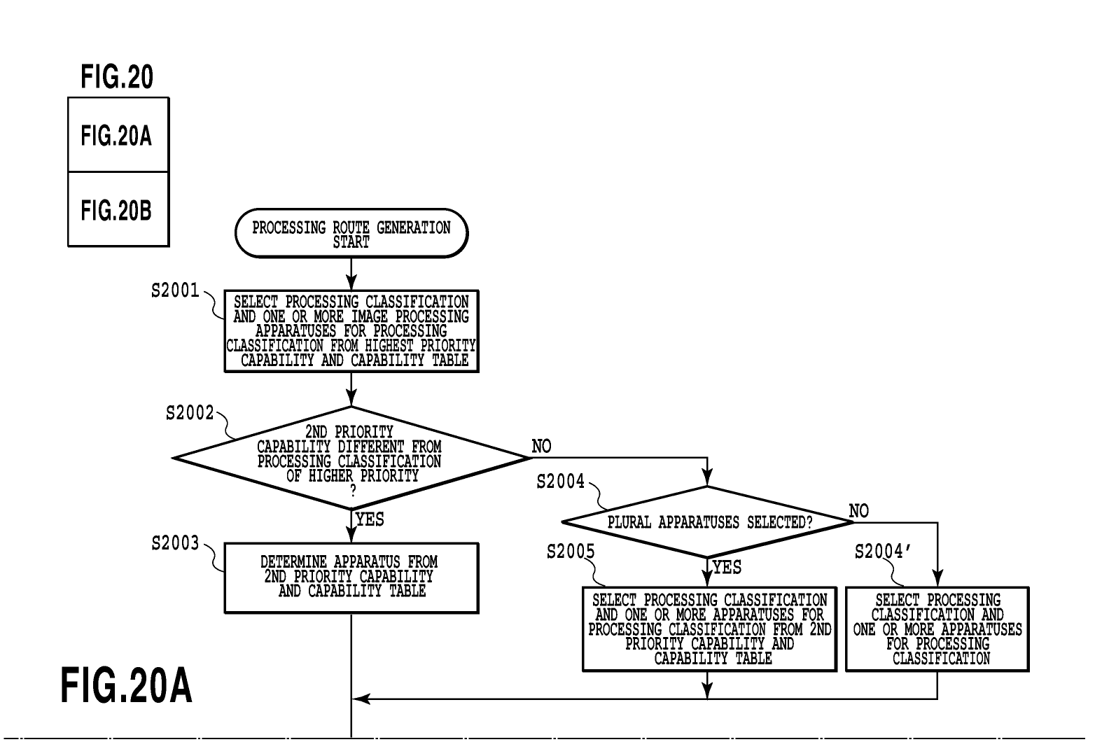

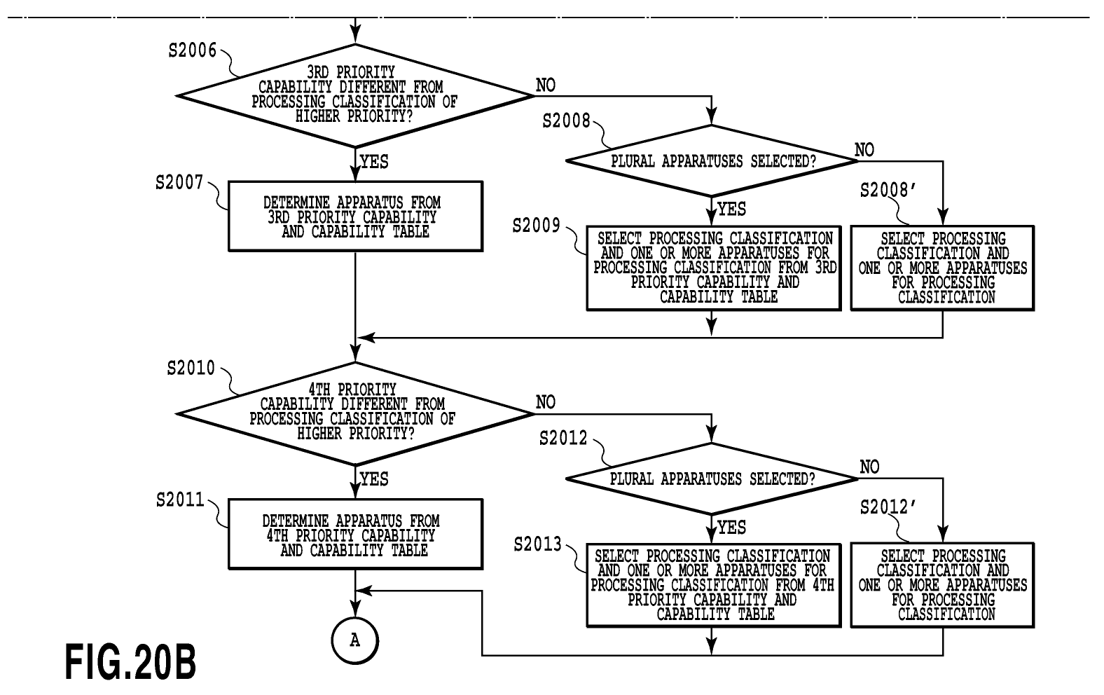

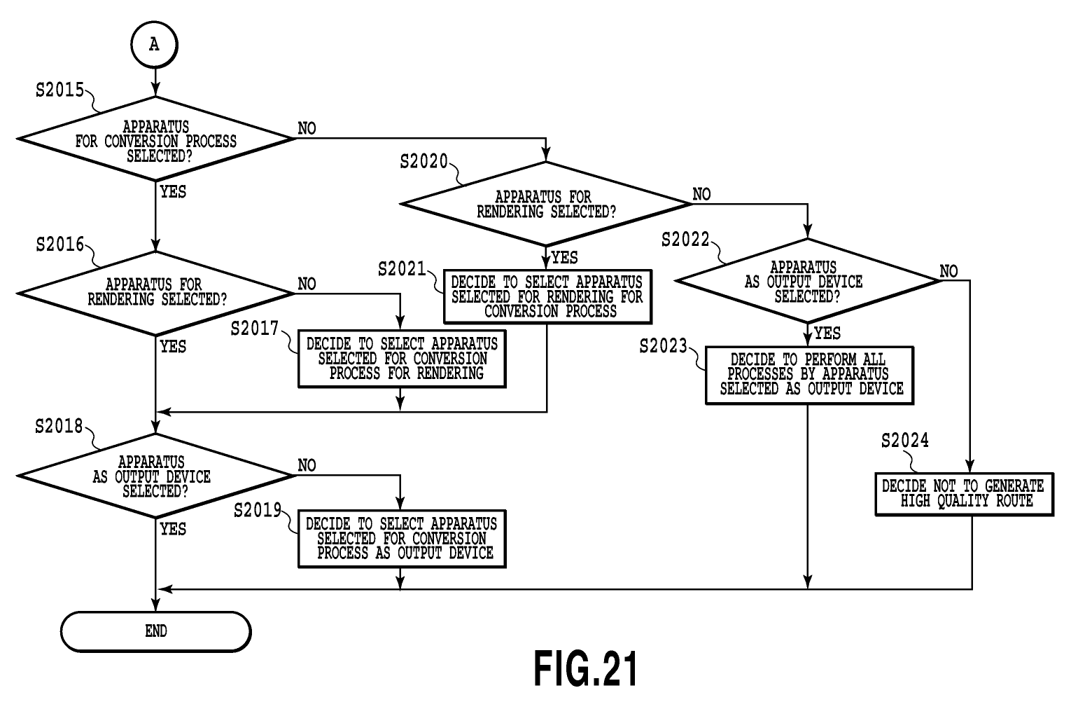

Next, the processing route generating flow indicated in step S1704 will be described with reference to FIGS. 20A, 20B and 21. The processing is processing that generates processing route information for high quality image.

In step S2001 in FIG. 20A, processing classification that should be first priority and an image processing apparatus capable of performing the processing of the processing classification at the best image quality are selected from the highest priority processing capability and the processing capability table that are generated as metadata of Document in S933, S1108. If, here, a plurality of the image processing apparatuses capable of processing at the best image quality exists, a plurality of the image processing apparatuses is selected.

In step S2002, whether the second priority processing capability is different from the higher priority processing classification or not is determined. As a result of the determination, when the second priority processing capability is different from the higher priority processing classification, processing classification and an image processing apparatus are selected from the second priority processing capability and the processing capability table in step S2003. If, here, a plurality of the image processing apparatuses capable of processing at the best image quality exists, a plurality of the image processing apparatuses is selected.

As a result of the determination in S2002, when the second priority processing capability is identical to the higher priority processing classification, an image processing apparatus capable of processing at the best image quality with respect to the highest priority processing capability and also capable of processing at the best image quality with respect to the second priority processing capability is selected in step S2004. Then, whether a plurality of the image processing apparatuses selected as a result of the selection exists or not is determined. As a result of the determination, when a plurality of the selected image processing apparatuses exists, a plurality of the image processing apparatuses having already been selected in S2001 and which is capable of performing the processing of the second priority processing capability at the best image quality is selected from the second priority processing capability and the processing capability table in step S2005.

Then, an image processing apparatus that mounts a CPU capable of processing at the highest speed is selected from among the plurality of the image processing apparatuses as an image processing apparatus that performs the processing of the processing classification that should be first priority.

As a result of the determination, when a plurality of the selected image processing apparatuses does not exist, the flow proceeds to step S2004′. In S2004′, an image processing apparatus capable of processing at the best image quality with respect to the highest priority processing capability and also capable of processing at the best image quality with respect to the second priority processing capability is selected as an image processing apparatus that performs the processing of the processing classification that should be first priority.

Following step S2003, S2004, or S2005, in step S2006 in FIG. 20B, whether a third priority processing capability is different from the higher priority processing classification or not is determined. As a result of the determination, when the third priority processing capability is different from the higher priority processing classification, processing classification and an image processing apparatus are selected from the third priority processing capability and the processing capability table in step S2007. If, here, a plurality of the image processing apparatuses capable of processing at the best image quality exists, a plurality of the image processing apparatuses is selected.

As a result of the determination, when the third priority processing capability is a processing classification identical to any one of the higher priority processing classifications, an image processing apparatus capable of performing the processing of the processing capability, a processing classification identical to the content of the third priority processing, among the highest priority and the second priority processing capabilities is identified. That is, either the image processing apparatus selected in S2001 or the image processing apparatus selected in S2003 is identified.

Then, whether a plurality of the selected image processing apparatuses that are identified image processing apparatuses and capable of processing at the best image quality with respect to the third priority processing capability exists or not is determined in step S2008. As a result of the determination, when a plurality of the selected image processing apparatuses exists, a plurality of image processing apparatuses that performs processing by the third priority processing capability and by the processing capability table is selected in step S2009. Then, an image processing apparatus that mounts a CPU capable of processing at the highest speed is selected from among the plurality of the image processing apparatuses as an image processing apparatus that performs the processing of the processing classification corresponding to the third priority processing capability identical to the highest priority or the second priority processing capability.

As a result of the determination, when a plurality of the selected image processing apparatus does not exist, the flow proceeds to step S2008′. In step 2008′, an image processing apparatus is selected as one that performs the processing of the processing classification corresponding to the third priority processing capability identical to the highest priority or the second priority processing capability.

Next, processing identical to that in S2006 to S2009 is performed in S2010 to 2013.

Following step S2011, S2012, or S2013, in step S2015 in FIG. 21, whether an image processing apparatus that performs the processing of the processing classification of conversion processing of the processing classification is selected or not in the processing in S2004, S2005, S2008, S2009, S2012, and S2013 is determined. As a result of the determination, when the image processing apparatus is selected, whether the image processing apparatus that performs the processing of the processing classification of the renderer is selected or not in the processing in S2004, S2005, S2008, S2009, S2012, and S2013 is determined in step S2016. As a result of the determination, when the image processing apparatus is not selected, the image processing apparatus that performs the processing of the processing classification of the renderer is made to be identical to the image processing apparatus that performs the processing of the processing classification of conversion processing in step S2017, and then the flow proceeds to step S2018.

In step S2018, whether an image processing apparatus that performs the processing of the processing classification of an engine is selected or not in the processing in S2004, S2005, S2008, S2009, S2012, and S2013 is determined. As a result of the determination, when the image processing apparatus is not selected, in S2019, an image processing apparatus that performs the processing of the processing classification of an engine is made to be identical to the image processing apparatus that performs the processing of the processing classification of the renderer. When the image processing apparatus is selected, the flow in FIGS. 20 and 21 terminates.

As a result of the determination in S2015 whether an image processing apparatus that performs the processing of the processing classification of conversion processing of the processing classification is selected or not, when the image processing apparatus is not selected, the flow proceeds to step S2020 to determine whether an image processing apparatus that performs the processing of the processing classification of renderer is selected. When the image processing apparatus is selected, in Step 2021, the image processing apparatus that performs the processing of the processing classification of conversion processing is made to be identical to the image processing apparatus that performs the processing of the processing classification of the renderer, and then the flow proceeds to step S2018.

As a result of the determination in step S2020, when the image processing apparatus is not selected, the flow proceeds to step S2022 to determine whether an image processing apparatus that performs the processing of the processing classification of an engine is selected. As a result of the determination, when the image processing apparatus is selected, in Step 2023, all processing is made to be identical to the image processing apparatus that performs the processing of the processing classification of an engine. Then the flow terminates.

As a result of the determination in step S2022, when the image processing apparatus is not selected, it is determined in step S2024 that no high quality route exists. Then the flow terminates.

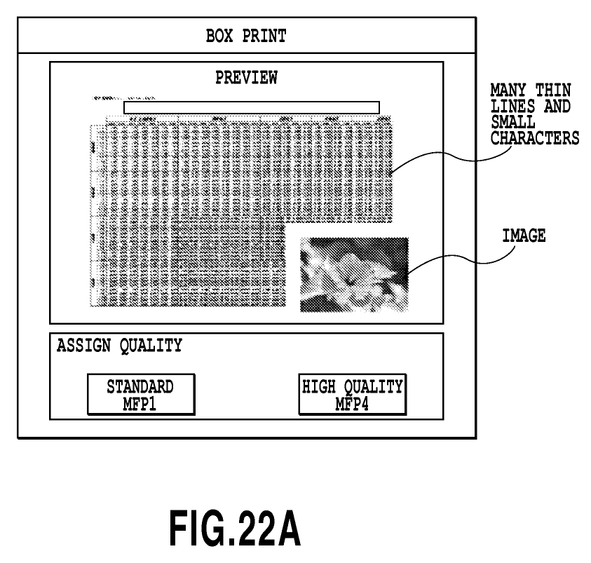

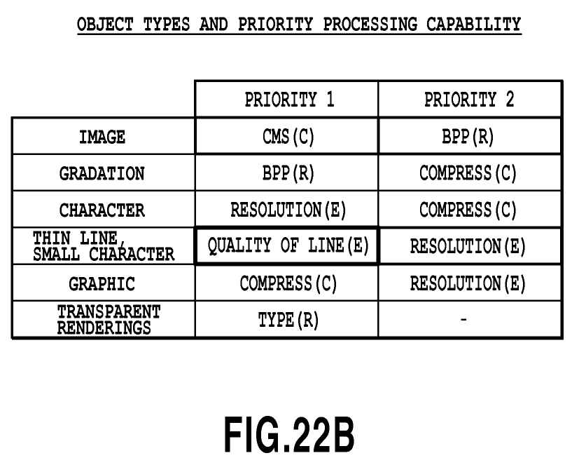

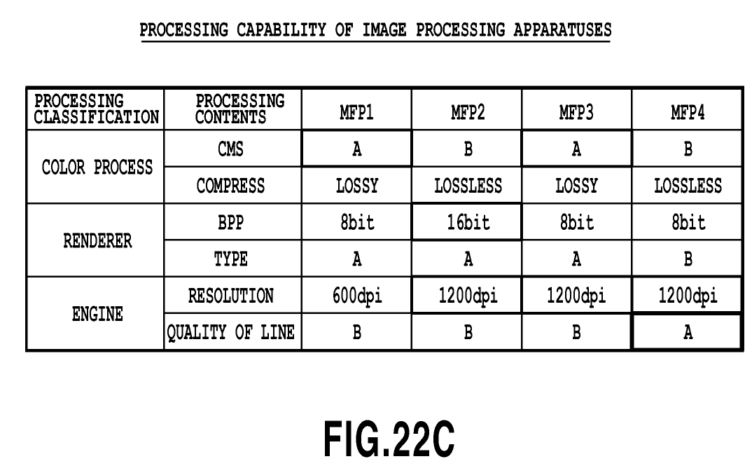

FIGS. 22A, 22B and 22C illustrate an UI screen displayed on the console with selected data, a priority processing capability table and a processing capability table, respectively.

The selected data (FIG. 22A) is firstly judged to contain many thin lines and small characters, and is secondary judged to contain many images at Document generation processing. By the priority processing capability table (FIG. 22B), the data is converted to metadata (FIG. 22C) in sequence of priority; thin line reproduction, resolution, color matching and tone.

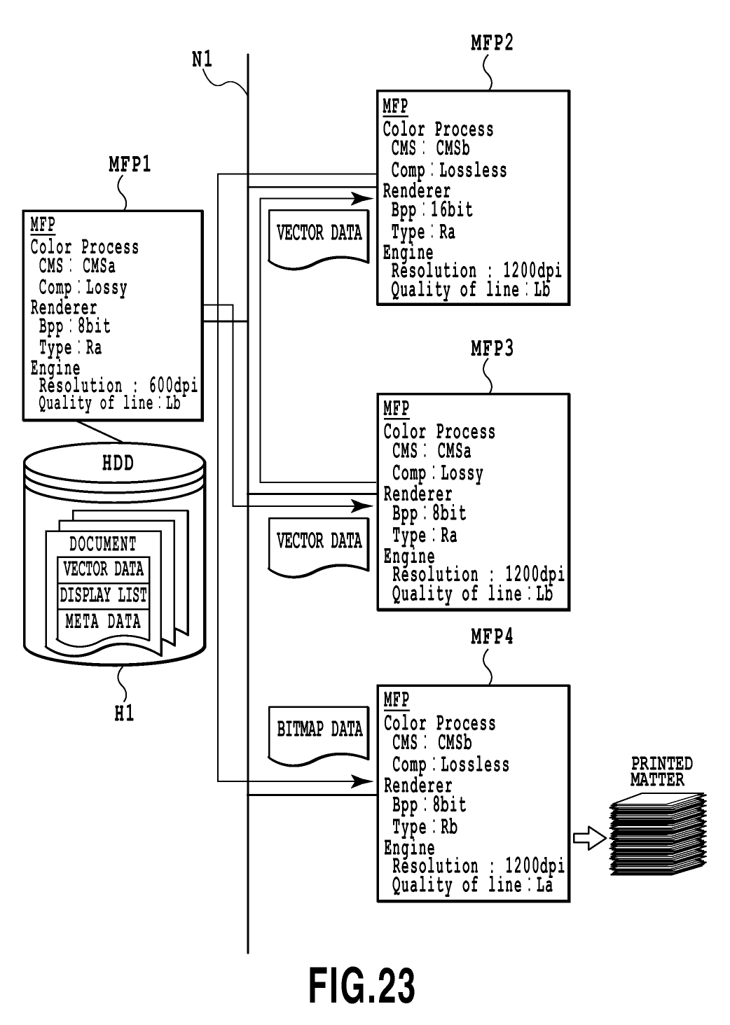

When Box Print processing applies to the Document data, MFP4 is selected by the highest priority of Quality of line based on the metadata. Either MFP3 or MFP1 is selected by the lower priority of CMS. Finally, by considering BPP, MFP2 is selected. As a result, according to processing capability referred to from the metadata, a processing route; MFP3 to MFP2 to MFP4 (or, MFP1 to MFP2 to MFP4) is selected. Then, as shown in FIG. 23, Document transfer and printing via network are implemented in order of the selected processing route.

In the description above, only output processing route for high image quality is selected. It may be possible to select second and third output processing route to add alternatives of standard and high quality, thereby allowing an operator to obtain more preferable results.

Further, it may be possible to select, when a plurality of routes exists, the route by considering a processing status of an image processing apparatus.

### Embodiment 2

In Embodiment 1, whenever output processing is performed, a route is selected and processing is actually performed at each image processing. In an embodiment, data converted at output processing is added to Document.

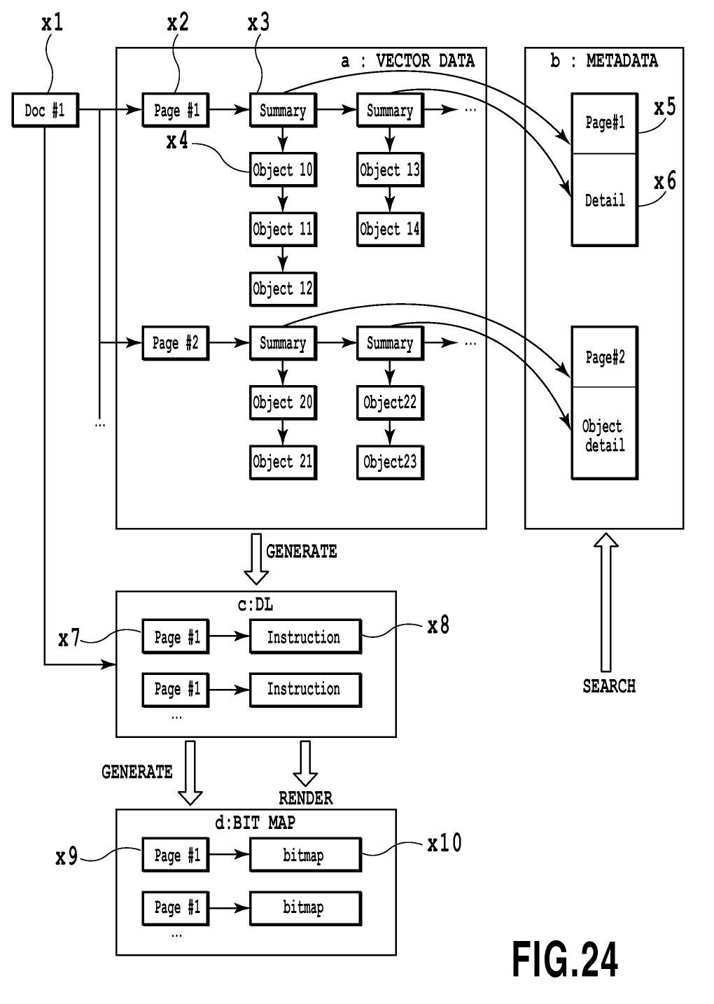

FIG. 24 illustrates data structure of Document according to the present embodiment.

Document according to the present embodiment has structure in which bit map (d) is added to the Document structure in FIG. 13.

Bit map (d) is a bit map generated by converting DL (c) by renderer. Management table of rendering information (instruction) in the pages and the like is described in page header (x9). Bit map (x10) is composed of such as resolution-dependent RGB bit map data.

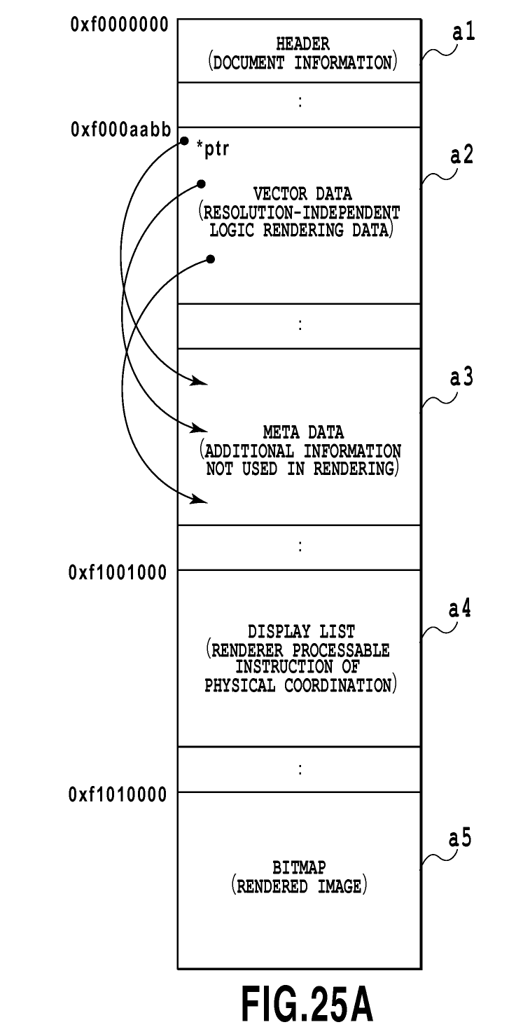

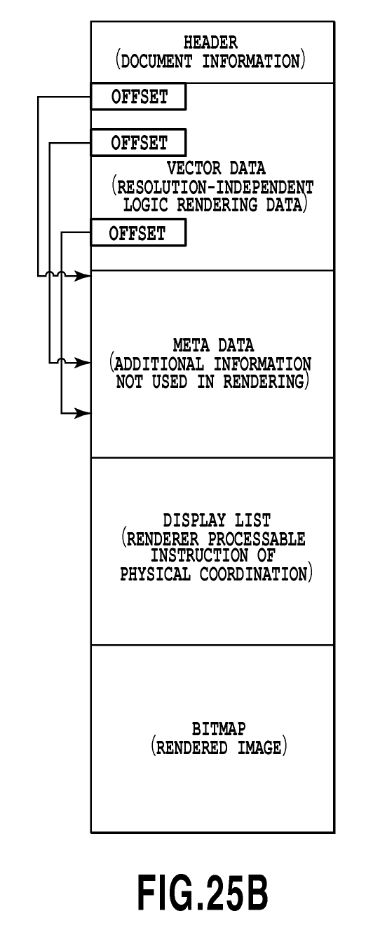

FIG. 25A is a diagram illustrating how the data structure explained in FIG. 24 is located on a memory. FIG. 25B is a diagram illustrating how the data structure explained in FIG. 24 is located on a file.

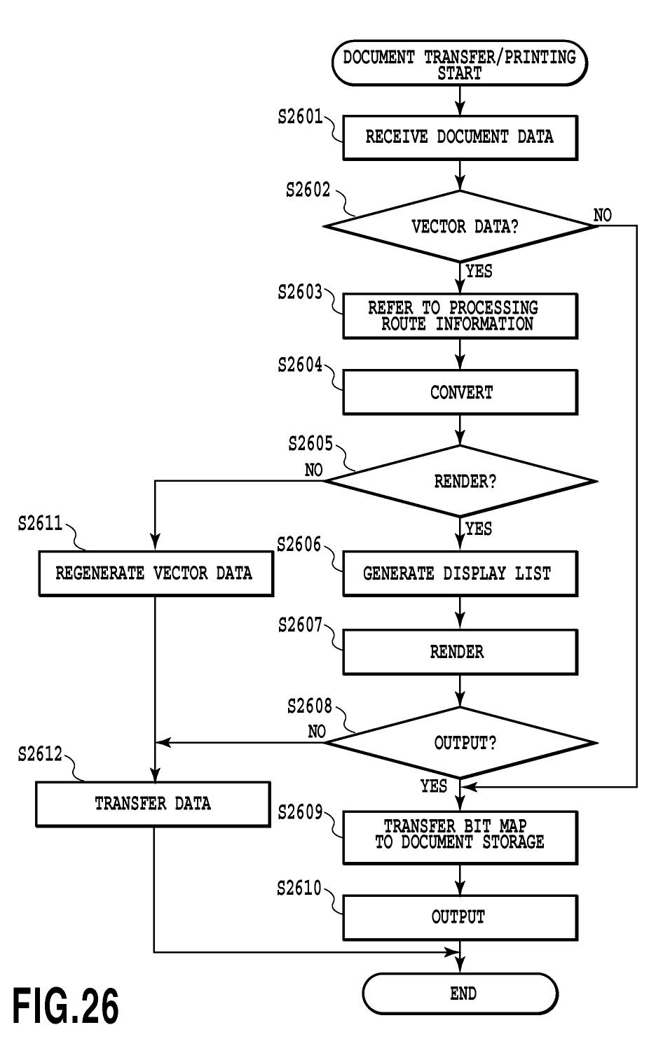

FIG. 26 illustrates Document transfer and printing processing. The processing is processing that transfers or prints out a generated Document.

In step S2601, the Document data is received. In step S2602, whether the Document is vector data or not is determined. As a result of the determination, when the Document is vector data, processing route information received at the same time as the Document is referred to in step S2603. In step S2604, conversion processing is performed in accordance with the processing route information. Next, in step S2605, by referring to the processing route information, whether or not to perform rendering is determined. As a result of the determination, when rendering is to be performed, DL is generated in step S2606. In step S2607, rendering is performed.

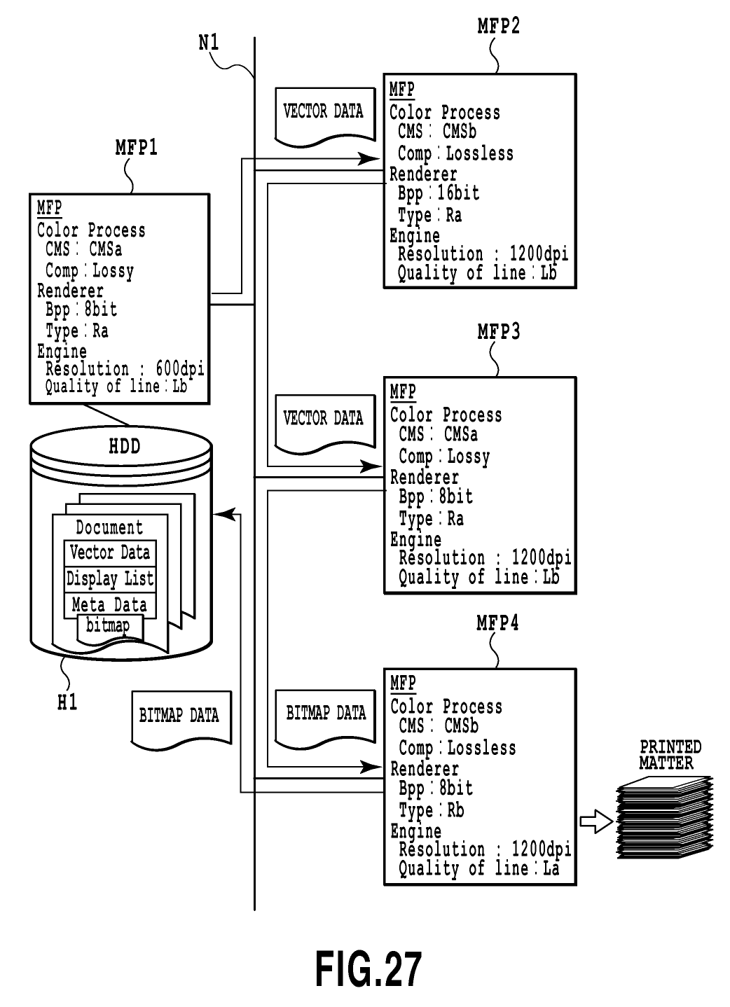

Next, in step S2608, whether or not to perform output processing is determined. As a result of the determination, when output processing is to be performed, the bit map is transferred to Document storage as shown in FIG. 27 in step S2609. In step S2610, output processing is performed.

At the determination in step S2605, when rendering is not to be performed, vector data is regenerated in step S2611. In step S2612, the vector data is transferred to other image processing apparatus in accordance with the processing route information. At the determination in step S2608, when output processing is not to be performed, the transfer processing in step S2612 is performed.

According to the present embodiment, by adding a converted data to Document in storage, when the same Document is selected, it may be possible to perform rendering output efficiently at high speed without conversion processing.

In the present embodiment, bit map data is transferred to Document storage. However, it may be possible to transfer vector data during processing.

### Other Embodiment

Various embodiments are described above. The present invention can be applied to a system composed of a plurality of devices and also to apparatus having a device. The device is, for example, a scanner, a printer, a PC, a copier, a multifunctional peripheral, and a facsimile.

The present invention can be implemented by supplying directly or remotely software program that realizes each of the functions in aforementioned embodiments to a system or a device, loading and executing the supplied program codes by a computer included the system and the like.

Therefore, a program code that is installed on the computer to realize functions and processing of the present invention can realize the present invention. In fact, the present invention involves a computer program to realize above-mentioned functions and processing.

In this case, when a computer program has functionality of computer program, configuration of the program, such as object codes, a program executed by an interpreter and script data to be supplied to OS is indifferent.

A storage medium supplying a program includes, for example, a flexible disk, a hard disk, an optical disk, a magneto-optical disk, MO, CD-ROM, CD-R, CD-RW and the like. Further, a storage medium includes magnetic tape, a non-volatile memory card, ROM, and DVD (DVD-ROM, DVD-R) and the like.

It may be possible to download a program from a web site on the Internet/intranet using a browser in a client computer. In fact, it may be possible to download a program itself according to the present invention, or a file that has a compressed program according to the present invention and a self-install function onto a storage medium such as a hard disk. Further, the present invention can be implemented by dividing program codes that compose a program according to the present invention into a plurality of files, downloading each of the files from different web sites. Therefore, a WWW sever that makes a plurality of users download a program file that realizes function processing according to the present invention on computer may be an element of the present invention.

It may be possible that a program according to the present invention is coded, stored in a storage medium such as CD-ROM, and delivered to users. In this case, it may be possible to install a program on a computer by making a user who goes clear predetermined condition download key information that encodes the coded program from a web site via Internet/intranet, encoding the coded program by the key information and executing the program.

It may also be possible that functions of aforementioned embodiments are realized by executing a loaded program by a computer. Further, it may be possible that OS and the like operating on a computer perform any actual processing based on an instruction of the program. As a matter of course, functions of aforementioned embodiments can be realized.

Furthermore, it may be possible that a program loaded from a storage medium is written on a memory equipped on an extender board inserted in a computer or an extender unit connected to a computer. It may be possible that CPU and the like equipped on the extender board or extender unit perform any actual processing based on an instruction of the program. In this way, functions of aforementioned embodiments can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-002486, filed Jan. 9, 2008, which is hereby incorporated by reference herein in its entirety.

What is claimed is:

1. An image processing apparatus in an image processing system constituted of a plurality of image processing apparatuses connected to a network, comprising:
judgment means for judging a type of data;
set means for setting priorities of image processings for said data in accordance with the judged type;
obtainment means for obtaining a plurality of image processing capabilities provided for said plurality of image processing apparatuses via said network; and
determination means for determining a processing route along which said data is processed through said plurality of image processing apparatuses; wherein image processings for said data are performed by transferring said data along the determined processing route.

2. The image processing apparatus according to claim 1, further comprising:
retainment means for retaining said priorities and said data as a document data.

3. The image processing apparatus according to claim 1, further comprising:
input means for inputting said data via said network; and
conversion means for converting at least a part of a region of the received data to a resolution independent data that does not depend upon a resolution.

4. The image processing apparatus according to claim 1, further comprising:
means for receiving a page description language via said network;
analysis means for analyzing the received page description language; and
conversion means for converting the analyzed result to a resolution independent data that does not depend upon an engine resolution.

5. The image processing apparatus according to claim 1, wherein
said judgment means judges types of said data to be which one of at least character, graphic, image, small character, thin line and gradation.

6. The image processing apparatus according to claim 1, wherein
said image processing capabilities include at least one of color conversion, compression, resolution, tone, rendering format and thin line reproduction.

7. An image processing method in an image processing system constituted of a plurality of image processing apparatuses connected to a network, comprising the steps of:
judging a type of data;
setting priorities of image processings for said data in accordance with the judged type;
obtaining a plurality of image processing capabilities provided for said plurality of image processing apparatuses via said network; and
determining a processing route along which said data is processed through said plurality of image processing apparatuses; wherein image processings for said data are performed by transferring said data along the determined processing route.

8. A program for causing a computer, in an image processing system constituted of a plurality of image processing apparatuses connected to a network, to execute the steps of:
judging a type of data;
setting priorities of image processings for said data in accordance with the judged type;
obtaining a plurality of image processing capabilities provided for said plurality of image processing apparatuses via said network; and
determining a processing route along which said data is processed through said plurality of image processing apparatuses; wherein image processings for said data are performed by transferring said data along the determined processing route.
